(19) United States
(12) Patent Application Publication
(10) Pub. No.: US 2004/0256009 A1
(43) Pub. Date: Dec. 23, 2004

(54) Digital faucet of variable flow

(76) Inventor: Joel Valenzuela, Ojinaga (MX)

Correspondence Address: Joel Valenzuela Hernandez, 7167 West Kentucky Dr. D, Lakewood, CO, 80226, US

(21) Appl. No.: 10/467,955

(22) Filed: Dec. 3, 2002

(30) Foreign Application Priority Data
Jun. 29, 2000 (MX) PA/A/2000/007053
Jun. 11, 2001 (WO) PCT/MX01/00035

(51) Int. Cl. F16K 11/08

(52) U.S. Cl. 137/607

(57) ABSTRACT

This invention is a faucet of two or one valve of flow and variable temperature for water, other liquids, gases and/or pulverized solids. It is operated through the digital control or intelligent control whether fixed or to remote control or through the system of voice and has a automatic closed.

The digital control operates pressing in form intermittent or prolonged the button to open or to close, and simultaneously it will show in the indicating scale the close, the progressive and total opening of the faucet. The faucet with intelligent control will allow the user to give to the quantity of flow and temperature, or choosing the previously established scales or calling of memory the conditions previously stored. The control with voice system allows the user to give instructions with voice, the language and the options mentioned previously in the intelligent control.

At present the mechanical mixer faucet that are utilized so much in shower, lavatory, sinks, etc., by their use present generally leaks of water. The maintenance and installation of this type of faucets become difficulty by the design, from time to time is required of retiring the ceramics of the showers, in the sinks and lavatories, by it reduced of the space, is required to retire totally the furniture to substitute them or to repair them.

The repairs to repair these faucets, many of the times are not found in existences, for which the user is seen in the need to acquire all the piece.

Also the existing sensor valves that do not mix the hot and cold water, the water flow is not variable when it is provided, but the water is without mixing and the supply of flow is fixed previously established.

The digital faucet of variable flow was designed thinking about the user, expecting to satisfy his expectations, thus facilitating the installation, use, maintenance, replacement of pieces and cleaning, exceeding to the conventional, since by his designs permits to vary the amount of water and temperature that desires the user, in digital form, to remote control or voice system. It offers the option to establish a time in which will remain open the faucet through the timer, which helps to close the faucet or faucets automatically in a determined interval of time, set to the needs of the user, for greater security of user, avoiding waste of water, some accident and reduction of costs due to the carelessness or to badly state of the faucets if some of these were left open.

This digital faucet of variable flow, by its compact designs, comes to revolutionize its use, in lavatories, sinks, Jacuzzi, bathtubs, showers, etc., giving him thus to the user the comfort and the innovation in its home, in its business, hospitals, restaurants, etc., likewise to the persons with physical disability.

The digital faucet of variable flow has innumerable advantages upon the conventional, being an innovating system and modem, is protected for the present request.

### DESCRIPTION OF THE INVENTION

The innovation of the digital faucet of variable flow has an easy handling for the user, its installation, and its maintenance is simple; it was classified in the following way:

1. Digital Faucet of Variable Flow of 2 Valves. With control:

a). Fixed and remote control of pressure or presence of 4 button.

b). Fixed and remote control of pressure or presence of 2 button.

c). Intelligent with remote control of:

Pressure.

Presence.

Radio frequency.

Infrared Rays.

Beam of light.

d). Voice system.

2. Digital faucet of Variable Flow of 1 Valve.

a). With control of 2 buttons.

1. Digital faucet of Variable Flow of 2 Valves

a). Digital faucet of Variable Flow of 2 Valves With control of 4 buttons.

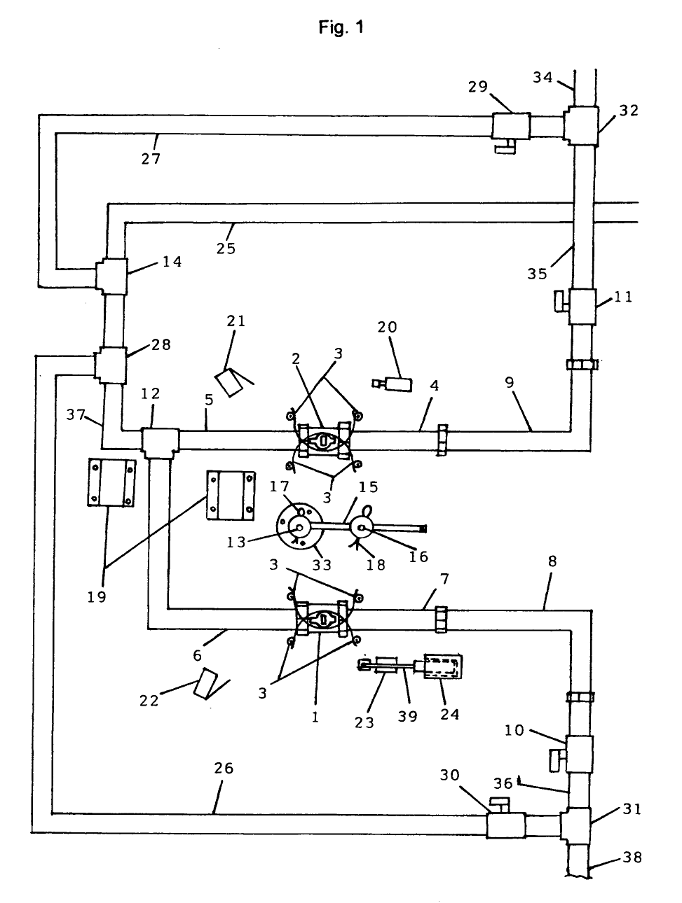

FIG. 1. Connections of Water, Supports and Axes of Gears.

Two ball valves are set (Numbs. 1 and 2) in the base or of the drawer, with the belts (Num. 3) or with a metal sheet welded to the ball valve in its base. 4 tubes are connected (Numbs. 4,5,6, y7) in the ball valves. In the tubes (Num. 4 and 7) the hoses are connected (Numbs. 8 and 9), the hose (Num. 8) is connected to the pass valve (of the taking of the hot water) (Num. 10) and the hose (Num. 9) is connected to the pass valve (of the taking of the cold water) (Num. 11).

In the other extreme of the tube (Num.6) joins with the connector type “T” (Num. 12), where this “T” is connected to the ball valve (Num.2), through a hose or tube (Num.5). To the other extreme of the connector type “T” (Num. 12) joins with the tube (Num.37).

The tube (Num.37) is joined to the connector type “T” (Num.28), this connector type “T” joins with the connector type “T” (Num. 14) through a tube.

The connector type “T” (Num.28) joins with the tube (Num.26) with the safety valve (Num.30) and this valve (Num.30) unites through a tube to the connector type “T” (Num. 31). In the other extreme of the connector type “T” (Num.31) without uniting, is connected to the pass valve (Num.10) through the tube (Num.36) and in the other extreme of the connector type “T” (Num.31) unites the tube (Num.38) that corresponds to the taking of the hot water.

The connector type “T” (Num.14) also joins with the tube (Num.27) with the safety valve (Num.29) and this safety valve unites with a tube to the connector type “T” (Num.32). To the other extreme of the connector type “T” (Num. 32) without connecting, joins with the pass valve (Num. 11) through the tube (Num. 35) and in the other extreme of the connector type “T” (Num. 32) it is joined with the tube (Num.34) that corresponds to it takes of the cold water. In the other extreme of the connector type “T” (Num.14) without connecting, unites the tube (Num. 25), which is the tube of supply of the flow of water mixed or without mixing.

The bases (Num. 19) that held the motor they are located approximately near the connector type “T” (Num.12)(As is shown in the FIG. 1), the dimensions of these bases are going to vary according to the dimensions of the motor.

Between of the valves is fixed the base (Num. 33), to the one that is welded perpendicularly in its center a bolt (Num. 13), to this bolt, the bolt(Num.15) is inserted through its ring that is found in its extreme, under to the ring carries a cotter pin (Num.17) that is inserted in the bolt (Num.13) which permits that the bolt (Num. 15) not slidedown.

In the central ring of the pin (Num.15) the bolt is inserted (Num.16), which in its lower extreme carries a cotter pin (Num.18), which permits that the pin does not leave.

Next to the ball valve (Num.1) the switches (Numbs.22 and 23) are placed. In the switch (Num.23), of its lever is connected a metal sheet (Num.39) to the concentric pin of the pull and box frame type solenoid (Num.24).

Next to the ball valve (Num.2) the switches (Numbs.20 and 21) are placed.

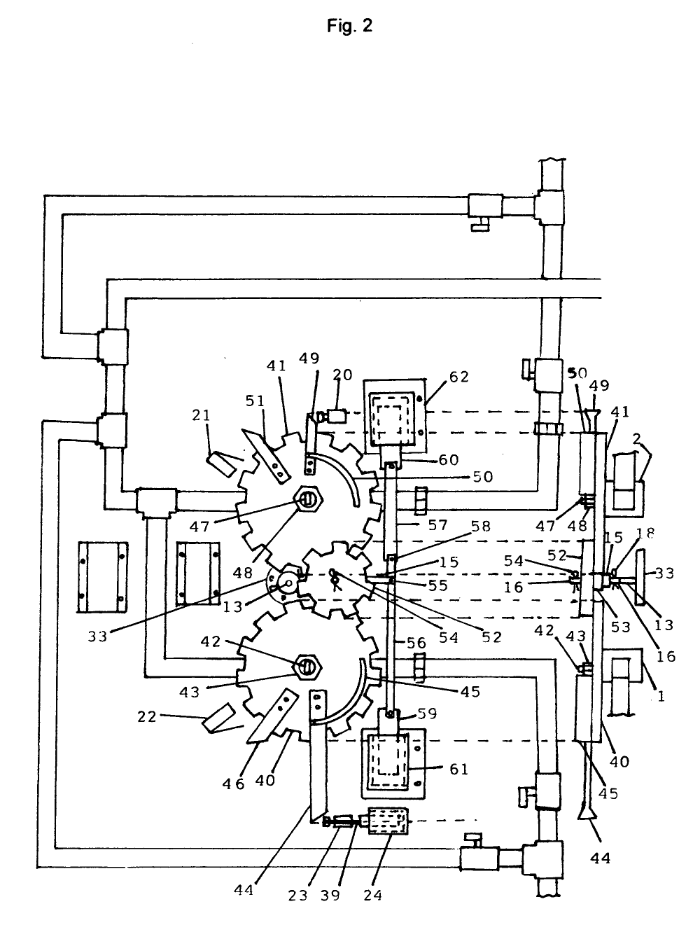

FIG. 2. Assembly and Operation of Gear.

Two gear (Numbs. 40 and 41), each one previously is grooved in its center to the offspring dimension of the ball valves.

The gear (Num.40) is inserted and is held with a nut (Num.43) to the offspring (Num. 42) of the ball valve (Num.1) that is shown in the FIG. 1. In the upper part of the gear are set 3 metal sheets (Numbs. 44, 45, and 46). The horizontal metal sheet (Num. 44) has a fold in its salient extreme of the gear, whose function is to drive the lever switch (Num. 23) when the ball valve is closed, or to drive the lever switch (Num. 22) when the ball valve is completely open. The metal sheet (Num.45) is fixed upon to metal sheet (Num. 44), this metal sheet (Num.45) is vertical with a curvature according to the gear (Num.40) curvature. In order to allow to vary the maximum opening for the supply, it can be installed the metal sheet (Num.46) separated to the metal sheet (Num.44) in the gear (Num.40) to a distance that permits to move in a rank the metal sheet until setting the opening desired of the ball valve (Num.1) of the FIG. 1, another option is to vary the position of the lever switch (Num.22) with regard to the lever switch (Num.23) obtaining also thus to set the maximum opening of the ball valve.

The gear (Num.41) is inserted and is held with a nut (Num.48) to the offspring (Num.47) of the ball valve (Num.2) FIG. 1. In the superior part of the gear is set 3 metal sheet (Numbs. 49,50 and 51). The horizontal metal sheet (Num.49) has a fold in its salient extreme upon gearing, whose function is to drive the switch (Num. 20) when the ball valve be closed, or to drive the switch (Num. 21) when the ball valve is completely open. Metal sheet (Num.50) is fixed upon to the metal sheet (Num.49), this metal sheet (Num.50) is vertical with a curvature according to the gear (Num.41).

In order to allow to vary the maximum opening for the supply, it is possible to be chosen to install metal sheet (Num.51) separated of metal sheet (Num.49) in the gear (Num.41) to a distance that permits to move in a rank the metal sheet, until setting the opening desired of the ball valve (Num.2) FIG. 1, another option is to vary the position of the switch (Num. 21) with respect to the switch (Num.20), also obtaining to set the maximum opening of the ball valve. The gear (Num.52) carries united in their center a small one gear (Num.53), which are inserted in the bolt (Num.16). In the superior part of this bolt carries a cotter pin (Num. 54), with the purpose the gears (Numbs. 52 and 53) do not leave.

The horizontal bolt (Num.15) carries in its other extreme a drilling where the bolt (Num.55) is inserted to unite metal sheet (Num.56), this metal sheet joins with metal sheet (Num.57) through the bolt (Num.58). To another extremes of the metal sheet (Numbs. 56 and 57) the concentric bolts (Numbs. 59 and 60) are held, these bolts are joined in the center of each the pull and box frame type solenoid (Numbs.61 and 62). The pull and box frame type solenoid is held one near each ball valve as is indicated in the figure.

The gear (Num. 53) that mesh with the gear (Num.40) or the gear (Num.41) depending on the solenoid that be activated, that is to say, upon activating the solenoid, exerts a contraelectromotive force in the bolt, sliding it toward inside of the solenoid, with it produces the displacement of the metal sheets (Numbs. 56 and 57) and when assembling the end of bolt in the rear part of the solenoid (Num.61) or (Num.62) according to it is the case, it does the effect of magnet, remaining united, which will maintain connected the gear (Num.53) with the gear (Num.40) or (Num.41) as be the case. It will be activated only one solenoid at the same time. In this figure shows a frontal view of the gear.

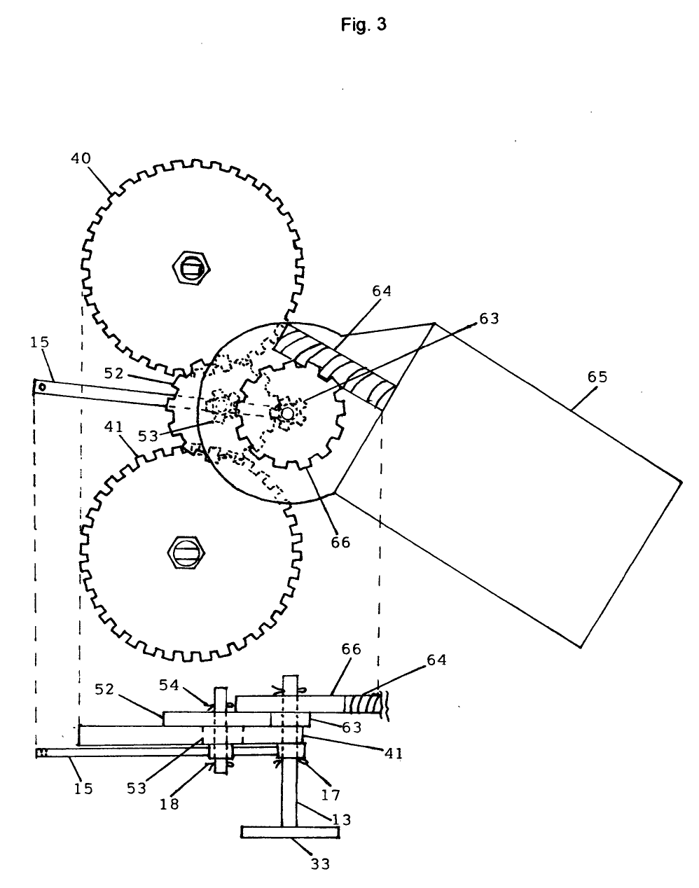

FIG. 3. Connection of the Gears with the Motor of Transmission Type I.

Upon activating the motor (Num.65) that has an arrangement of the gears of screw, will move this screw (Num.64), that is the axis of the motor, the screw will rotate in direction of the polarity of the voltage that is applied it, this screw will be meshed with the gear (Num.66), which will move it and this at the same time, will move another gear (Num.63) that is united to its center. The gear (Num.63), will be always connected to the gear (Num.52). The gear (Num.53) that goes united to the center of the gear (Num.52) will provoke movement in any of the gears (Num.40) or (Num.41) that will open or will close the ball valve (Num.1) or (Num.2) of the FIG. 1, depending of the direction of the motor rotation, as long as anyone of the two solenoids has been activated. In this figure is shown a frontal view of the relations of the gears connections with the motor.

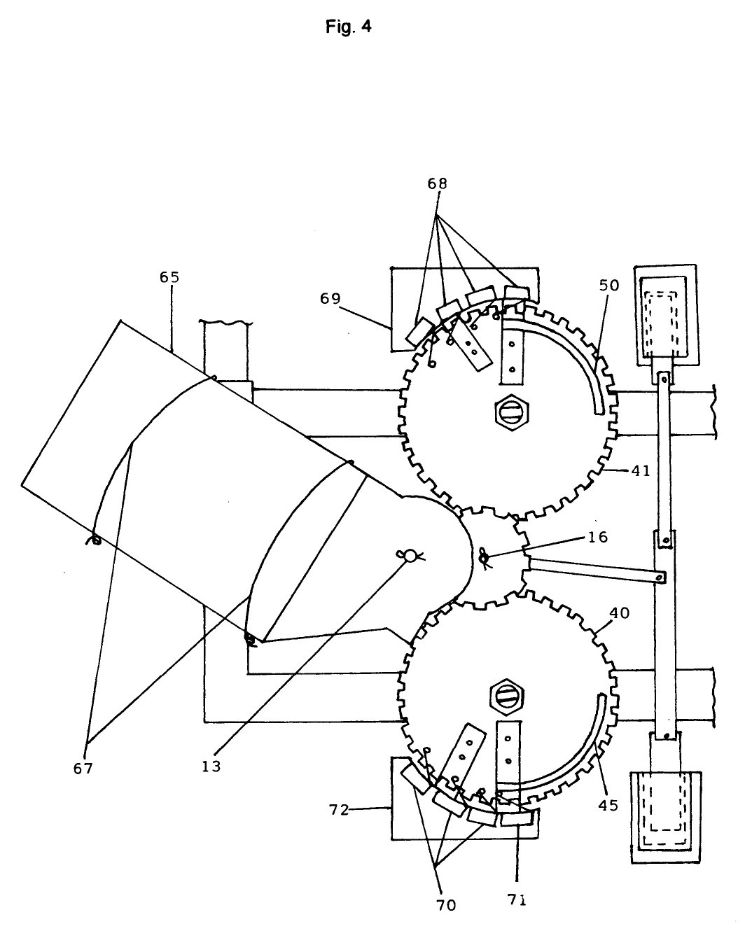

FIG. 4 The Motor and Switches Assembly.

The motor (Num.65) is assembled through the orifice of the gear (Num.63) FIG. 3 in the bolt (Num.13) FIG. 2 or FIG. 3, in the other motor extreme is held through belts (Num.67) to the bases (Num.19) FIG. 2.

Among the switches (Numbs.22 and 23) FIG. 1, to the superior part of these are fixed a curved metal sheet (Num.72), the switches (Numbs.70 and 71) are set, that will activate the yellow leds in the digital button control that they show the progressive opening of the ball valve (Num.1) FIG. 1 (For the hot water).

When the gear (Num.40) rotates in direction of the clockwise, will go driving the switches (Numbs.70 and 71) through metal sheet(Num.45), to the extent to the opening of ball valve (Num.1) FIG. 1 (For the hot water) and if rotates in opposite direction, will became inactive the switches (Numbs.70 and 71), to the extent to the closing valve.

Among the switches (Numbs. 20 and 21) of the FIG. 2, in the upper side of these are fixed a curved metal sheet (Num.69), the switches (Num.68) are set that will activate the yellow leds in the digital button control that they show the progressive opening of the ball valve (Num.2) FIG. 1 (of the cold water).

When the gear (Num.41) rotate in opposite direction of the clockwise will go driving the switch (Num. 68) through metal sheet (Num.50), to the extent that go opening the ball valve (Num. 2) FIG. 1 (of the cold water) and if rotates in direction of the clockwise, will become inactive the switch (Num.68) to the extent that go closing this valve.

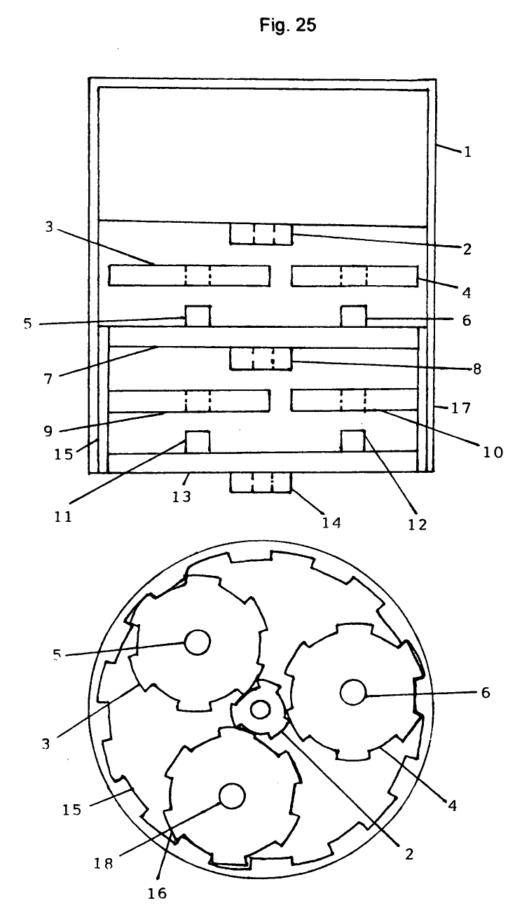

FIG. 25 Motor and Transmission Type II.

The transmission (Num.17) is connected to the motor (Num.1) the gear (Num.2) of this motor, that mesh with the gears (Numbs.3, 4 and 16) and these are inserted in the respective bolts (Numbs. 5,6, and 18) fixed aside of the disc (Num.7) and to the other side of this disc has fixed in its center the gear (Num.8). The gear (Num.8) is connected with the gears (Numbs. 9,10 and 16) and these are inserted in the respective bolts (Numbs. 11,12 and 18), fixed aside of the disc (Num.13) and to the other side of this disc, has fixed in its center the gear (Num. 14).

The gear (Numbs. 3,4,9 and 10) are connected also with the inner gear of the transmission (Num.15).

In the frontal view the connection of the gears (Numbs. 2,3,4,15 and 16) is observed.

This view, is the same for the connection gear (Numbs. 8,9,10,15 and 16).

The gear (Num.16) are 2, one for the first connection and the other for the second connection, previously mentioned, these gears (Num.16) they are assembled in bolts in its respective discs likewise the gears (Numbs. 3,4,9 and 10).

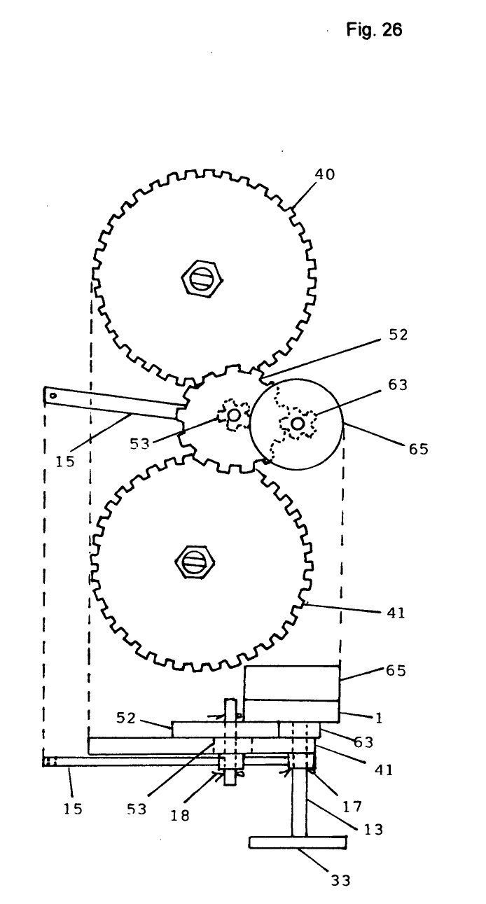

FIG. 26 Connection of the Gear with the Transmission Type II and Motor.

Upon activating the motor one (Num.65) or (Num.1) FIG. 25 is united to the transmission (Num.1) Type II or (Num.17) FIG. 25, the gear resultant (Num.63) or (Num.14) FIG. 25 is connected with the gear (Num.52). The gear (Num.53) that goes united to the center of the gear (Num.52) will provoke movement in any of the gear (Num.40) or (Num.41) that will open or will close the ball valve (Num.1) or (Num.2) of the FIG. 1, depending on the direction of motor rotation, as long as has been activated any of the 2 solenoids. In this figure a frontal view a relation of the connections of the gear with the transmission is shown.

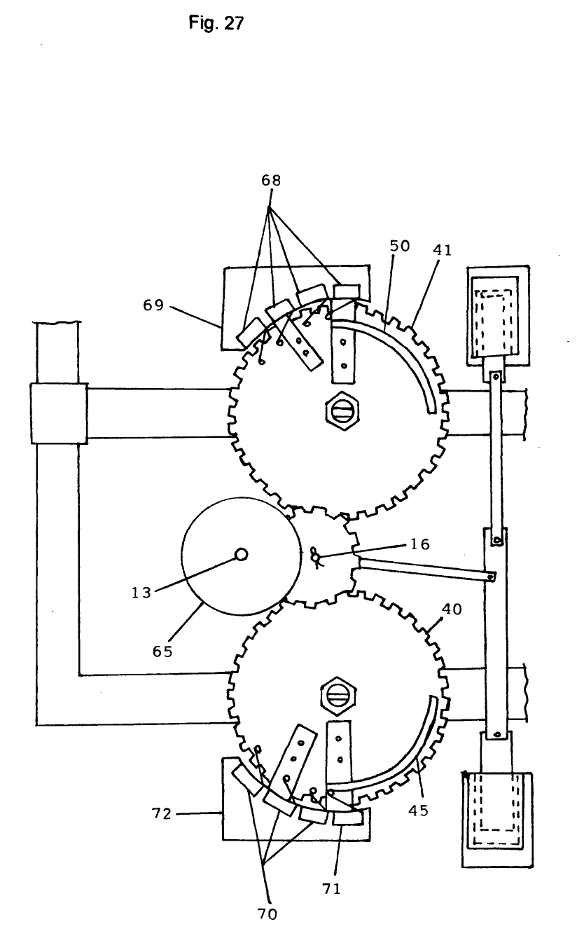

FIG. 27 Assembly of the Transmission Type II with the Motor and the Switches.

The motor is joined with the transmission (Num.65) through the orifice of the gear (Num.65) FIG. 3 in the bolt (Num. 13) FIG. 2 or FIG. 3.

Among the switches (Numbs.22 and 23) FIG. 1 in upper part of these are fixed a curved metal sheet (Num.72), this is set the switches (Numbs.70 and 71) that will activate the yellow leds in the digital control showing the progressive opening of the valve (Num. 1) FIG. 1 (For the hot water).

When the gear (Num.40) rotates in direction of the clockwise will go driving the switches (Numbs.70 and 71) through metal sheet (Num.45) to the extent that go opening the ball valve (Num.1) FIG. 1 (For the hot water) and if rotates in opposite direction will go deactivating the switches (Numbs. 70 and 71), to the extent that go closing this valve.

Among the switches (Numbs. 20 and 21) of the FIG. 2, in the upper part of these, are fixed a curved metal sheet (Num.69), they are set the switches (Num.68) that they will activate the yellow leds in the digital control, that they show the progressive opening of the ball valve (Num.2) FIG. 1 (of the cold water).

When the gear (Num.4) rotate in opposite direction of the clockwise will go driving the switch (Num.68) through metal sheet (Num.50), to the extent that go opening the ball valve (Num.2) FIG. 1 (of the cold water) and if rotates in direction of the clockwise, will go deactivating the switch (Num.68) to the extent that go closing this valve. In the FIG. 1, FIG. 2, FIG. 3 and FIG. 4, as in the FIG. 1, FIG. 2, FIG. 25, FIG. 26 and FIG. 27 is maintained the same number assigned to indicate each one of the part, depending if the part is in the figure, also this assignment will indicate the assembly sequence of the electronic system of control. It can be elected for any type of transmission before mentioned or other.

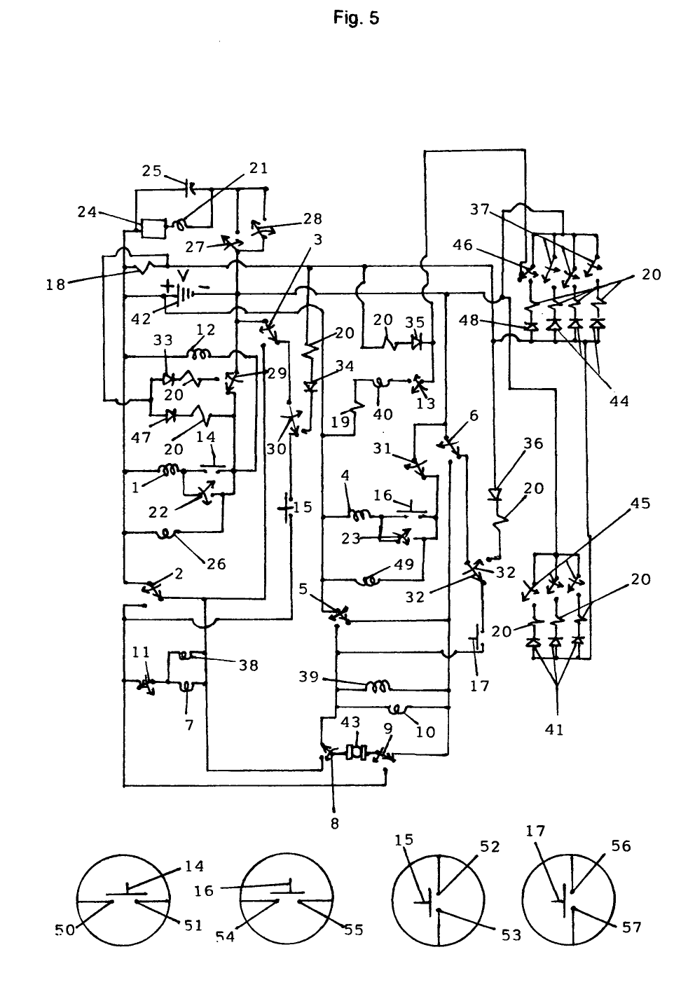

FIG. 5. Electronic Circuit.

The electronic circuit consists of the following components:

2 switches of 2 contacts each one (Numbs.2 and 3) of the relay and its coil (Num.1).

2 switches of 2 contacts each one (Numbs.5 and 6) of the relay and its coil (Num.4).

2 switches of 2 contacts each one (Numbs.8 and 9) of the relay and its coil (Num.7).

2 switches of 2 contacts each one (Numbs.22 and 23) of the Coil (Num.21).

1 switch of 1 contact (Num. 27) of the relay and its coil (Num.26).

1 switch of 1 contact (Num. 28) of the relay and its coil (Num.49).

1 switch of 1 contact (Num. 11) of the relay and its coil (Num.10).

1 switch of 1 contact (Num. 13) of the relay and its coil (Num.12).

Momentary button (Num.14) to close the ball valve (Num.2) FIG. 1 (of the cold water).

Momentary button (Num.15) to open the ball valve (Num.2) FIG. 1 (of the cold water).

Momentary button (Num.16) to close the valve ball (Num.1) FIG. 1 (of the hot water).

Momentary button (Num.17) to open the ball valve (Num.1) FIG. 1 (of the hot water).

Capacitor (Num.25).

Resistances (Numbs. 18, 19, and 20).

Timer (Num.24).

Switch (Num.29) or (Num.20) of the FIG. 2 for the ball valve (Num.2) FIG. 1 (of the cold water).

Switch (Num.30) or (Num.21) of the FIG. 2 for the ball valve (Num.2) FIG. 1 (of the cold water).

Switch (Num.31) or (Num.23) of the FIG. 2 for the ball valve (Num.1) FIG. 1 (of the hot water).

Switch (Num.32) or (Num.22) of the FIG. 2 for the ball valve (Num.1) FIG. 1 (of the hot water).

Pull type solenoid (Num.38) or (Num.62) FIG. 2.

Pull type solenoid (Num.39) or (Num.61) FIG. 2.

Pull type solenoid (Num.40) or (Num.24) FIG. 2. Motor (Num. 43) or (Num. 65) FIG. 4.

Voltage with the symbol “V” (Num.42).

The switches (Num.37) or (Num.70) in the FIG. 4 that activate the yellow leds of the ball valve (Num.1) FIG. 1 (of the hot water).

The switches (Num.45) or (Num.68) in the FIG. 4 that activate the yellow leds of the ball valve (Num.2) FIG. 1 (of the cold water).

Red led (Num.33) that indicates that is closed the ball valve (Num.2) FIG. 1 (of the cold water).

Red led (Num.35) that indicates that is closed the ball valve (Num.1) FIG. 1 (of the hot water).

Red led (Num.34) that indicates that is open the ball valve (Num.2) FIG. 1 (of the cold water).

Red led (Num.36) that indicates that is open the ball valve (Num.1) FIG. 1 (of the hot water).

Yellow leds (Num.41) of the valve (Num.2) FIG. 1 (of the cold water).

Yellow leds (Num.44) of the valve (Num.1) FIG. 1 (of the hot water).

The switch (Num.48) or (Num.71) in the FIG. 4 is the first one that active when is opened the ball valve (Num.1) FIG. 1 (of the hot water).

The first one yellow led (Num.47) that active when is opened the ball valve (Num.2) FIG. 1 (of the cold water).

The first one yellow led (Num.48) that active when is opened the ball valve (Num. 1) FIG. 1 (of the hot water).

To the pressing the momentary button (Num.15) to open the ball valve (Num.2) FIG. 1 (of the cold water), will circulate current in the following components:

In the switches (Numbs. 2,3,30 and 11) without having change of state in these.

In the pull type solenoid (Num.38) or (Num.62) FIG. 2, in the coil (Num.7) of the relay that will provoke change of state of the switches (Numbs. 8 and 9) by which it will connect the motor (Num.43).

By the led (Num.47) and resistance (Num. 20), to the extent that go opening the ball valve will be activated, later the switches (Num.45) they will go driving, provoking the passage of current by the resistance (Num.20) and the leds (Num.41). By the coil (Num.12), generating change of state in the switch (Num. 13).

To the pressing the momentary button (Num.14) to close the ball valve (Num.2) FIG. 1 (of the cold water), will circulate current in the following components, with the condition that does not have change of state the switch (Num.29).

By the coil (Num.1) of the relay, driving the switches (Numbs.2 and 3), connecting the switch (Num.11), the coil (Num.7) of the relay, the pull type solenoid (Num.38). The coil (Num.7) of the relay will drive the switches (Numbs. 8 and 9) connecting the motor (Num.43), then will circulate an inverse current in the motor when is pressing the momentary button (Num.15).

When the switch (Num.29) changes of state the will connect the resistance (Num.20) and the led (Num.33), this happens when closes completely the ball valve (Num.2) FIG. 1.

When the switch (Num.30) changes of state will connect the resistance (Num.20) and led (Num.34), this happens when is opened completely the valve (Num.1) FIG. 1 (of the cold water). Through the coil (Num.26) of the relay, driving the switch (Num.27), with the condition that the switch (Num.29), has not suffered change, that is to say, that the ball valve has not closed. The switch (Num.27) will connect the capacitor (Num.25), the counter (Timer) (Num.24), coil (Num.21) of the relay, activating the switch (Num.22), depending on the programmed time by the timer, complies with the function of closing the valve of the cold water.

To the pressing the button of momentary pressure (Num.17) to open the ball valve (Num.1) FIG. 1 (of the hot water), will circulate current in the following components:

By the switches (Numbs. 5,6, and 32) without having change of state of these.

Through the pull type solenoid. (Num.39) or (Num.61) FIG. 2.

By the coil (Num.10) of the relay will provoke change of state in the switch (Num. 11).

In the switches (Numbs. 8 and 9) don not have change of state the motor (Num.43) will be connected.

In relation to the ball valve of the hot water be opened (Num.1) FIG. 1 will be activated first the switch (Num.46) and will connect the resistance (Num.20) and the led (Num.48), later will activate the switches (Num.37) connecting the resistance (Num.20) with the leds (Num.44).

When the switch (Num.13) changing of state will be connected the pull type solenoid (Num.40) or (Num.24) FIG. 2 and the resistance (Num.19). The pull type solenoid (Num.40) upon is activated, will pull with its concentric bolt the lever of the switch (Num.23) FIG. 2 through metal sheet (Num.39) FIG. 2.

To the pressing the button of momentary pressure (Num.16) to close the valve of the hot water (Num.1) FIG. 1, with the condition that does not have change of state the switch (Num.31), will circulate current through the following components:

By the coil (Num.4) of the relay will activate the switches (Numbs. 5 and 6), connecting the coil (Num.10) of the relay, which will provoke change of state in the switch (Num.11). Also they will be connected, the coil (Num.39) and the motor (Num.43), as long as do not exist change of state in the switches (Numbs. 8 and 9), the motor (Num.43) will be connected, then will circulate an inverse current in the motor to the one that circulates when pressing the momentary button (Num.17). With the condition that does not have change of state in the switch (Num.46) will be connected the resistance (Num.20) and the led (Num.35), the led will indicate, that the valve (of the hot water) is closed.

When the switch (Num.32) or (Num.22) FIG. 2 changes of state, will connect the resistance (Num.20) and the led (Num.36), this happens when is opened completely the valve (Num.1) FIG. 1 (of the hot water).

Through the coil (Num.49) of the relay, drives the switch (Num.28), with the condition that the switch (Num.31), has not suffered change, that is to say, that the ball valve has not closed, this switch (Num.28) will connect the capacitor (Num.25), the counter (Timer) (Num.24) and the coil (Num.21) of the relay, activated the switch (Num.23) depending on the programmed time by the counter, complies with the function of closing the ball valve (Num.1) FIG. 1 (of the hot water).

The quantity of switches (Numbs.37 and 45) and the leds (Numbs. 33, 34, 35, 36, 41, 44 and 47) they can vary depending on the scale that is established.

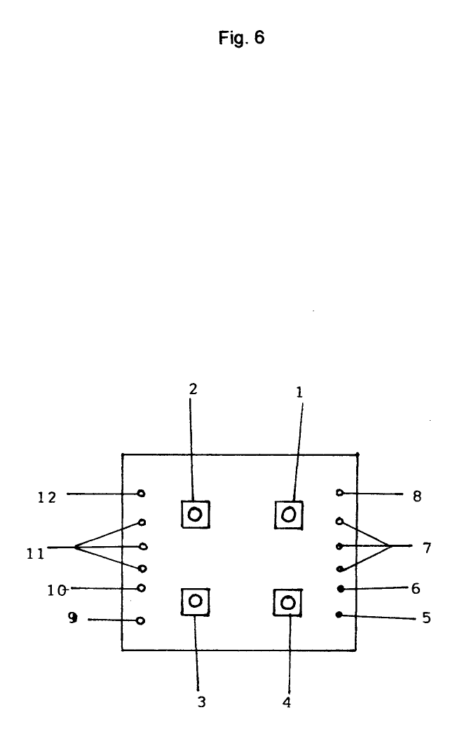

FIG. 6 Button Control.

This control is connected to the circuit of the FIG. 5. The momentary pressure button (Num.1) or (Num.15) FIG. 5 is for opening and the momentary pressure button (Num.4) or (Num.14) FIG. 5 is for closing the valve (Num.2) FIG. 1 (of the cold water). The button of momentary pressure (Num.2) or (Num.17) FIG. 5 is to open and the momentary pressure button (Num.3) or (Num.16) FIG. 5 to close the valve (Num.2) FIG. 1 (of the cold water).

Illuminated of indicatives leds for the cold water valve (Num.2) FIG. 1:

The red led (Num.5) or (Num.33) FIG. 5, indicates that the valve is completely closed.

The yellow led (Num.6) or (Num.47) FIG. 5 is the first one that is active when the valve is opened.

The yellow leds (Num.7) or (Num.41) FIG. 5 are the scale that indicates progressively the opening of the valve.

The green led (Num.8) or (Num.34) FIG. 5 indicates that the valve is completely open.

Illuminating the indicative leds for the hot valve of water (Num.1) FIG. 1: The red led (Num.9) or (Num.35) FIG. 5, indicates that the valve is completely closed. The yellow led (Num.10) or (Num.48) FIG. 5 is the first one that active when the valve is opened.

The yellow leds (Num.11) or (Num.44) FIG. 5 are the scale that indicates progressively the opening of the valve.

The green led (Num.12) or (Num.36) FIG. 5 indicates that the valve is completely open. For the momentary button (Numbs. 1, 2, 3 and 4) or (Numbs.14,15,16 and 17) FIG. 5:

When pressing in instantaneous form anyone of the buttons, will open or will close the ball valve according to the one that be activated. If it is maintained pressing any of the button, will be opened or will close the ball valve that has been activated, until the moment is left press the button.

b). Digital Faucet of Variable Flow of 2 Valves With Control of 2 Button.

Parts, assembly and description of the FIG. 1, FIG. 2, FIG. 3 and FIG. 4 of is the digital faucet of variable flow of 2 valves of 4 button they correspond also for the faucet of control of 2 button except for the electronic circuit and the button control that they are described subsequently:

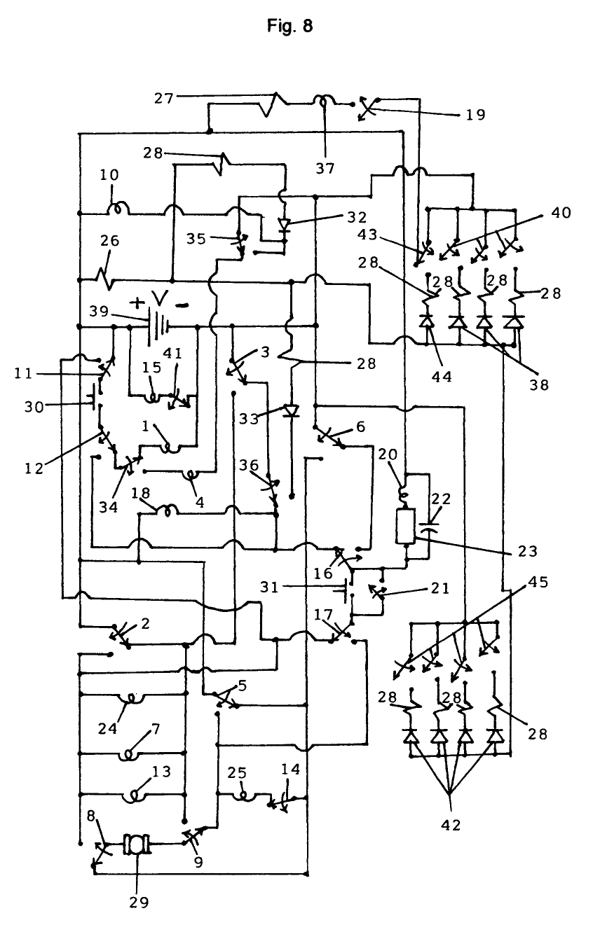

FIG. 8 Electronic Circuit for Control of 2 Button.

The electronic circuit is consist of the following components: Coil (Num.1) of the relay and its 2 switches of 2 contacts each one (Numbs. 2 and 3).

Coil (Num.4) of the relay and its 2 switches of 2 contacts each one (Numbs.5 and 6).

Coil (Num.7) of the relay and its 2 switches of 2 contacts each one (Numbs.8 and 9).

Coil(Num.10) of the relay and its 2 switches of 2 contacts each one (Numbs.11 and 12).

Coil (Num.15) of the relay and its 2 switches of 2 contacts each one (Numbs.16 and 17).

Coil (Num.13) of the relay and 1 switch of 1 contact each one (Num.14).

Coil (Num.18) of the relay and 1 switch of 1 contact each one (Num 19).

Coil (Num.20) of the relay and 1 contact each one (Num.21).

Capacitor (Num.22).

Resistances (Numbs. 26, 27 and 28).

Timer (Num.23).

Switch (Num.36) or (Num.20) of the FIG. 2 for the ball valve (Num.2) FIG. 1 (of the cold water).

Switch (Num.34) or (Num.21) of the FIG. 2 for the ball valve (Num.2) of FIG. 1 (of the cold water).

Switch (Num.41) or (Num.23) of the FIG. 2 for the ball valve (Num.1) FIG. 1 (of the hot water).

Switch (Num.35) or (Num.22) of the FIG. 2 for the ball valve (Num.1) FIG. 1 (of the hot water).

The pull type solenoid (Num.24) or (Num.62) FIG. 2.

The pull type solenoid (Num.25) or (Num.61) FIG. 2. The pull type solenoid (Num.37) or (Num.24) FIG. 2.

Motor (Num.29) or (Num.65) FIG. 4.

Button of momentary pressure (Num.30) to open.

Button of momentary pressure (Num.31) to close.

Voltage with the symbol “V” (Num.39).

The yellow leds (Num.38) that indicate the progressive opening of the ball valve (Num.1) FIG. 1 (of the hot water).

The yellow leds (Num.42) that indicate the progressive opening of the ball valve (Num.2) FIG. 1 (of the cold water).

The switches (Num.40) or (Num.70) FIG. 4 that activate the yellow leds of the ball valve (Num.1) FIG. 1 (of the hot water).

The switches (Num.45) or (Num.68) FIG. 4 that activate the yellow leds of the ball valve (Num.2) FIG. 1 (of the cold water).

The red led (Num.33) indicates that is closed completely the ball valve (Num.2)(of the cold water).

The switch (Num.43) or (Num.71) FIG. 4 is the first one that is active when is opened the ball valve (Num.1) FIG. 1 (of the hot water).

The first one yellow led (Num. 44) that is active when is opened the ball valve (Num.1)(of the hot water).

The green led (Num.32) that indicates that is open completely the ball valve (Num. 1)(of the hot water).

When is closed the 2 ball valves of the cold water (Num.2) FIG. 1 and the hot water (Num.1) FIG. 1, according go pressing the momentary pressure button (Num.30), will open the first ball valve of the cold water, being this open, the valve of the hot water will be opened later and will begin to be mixed with the cold water, both will be opened until the maximum opening that has been established. When continuing pressing the momentary pressure button (Num.30) will begin to close the valve of the cold water, without having changes in the hot water valve, until is completely closed the cold water valve, with this will have the supply of the hot water only. To the pressing the momentary pressure button (Num.30) in its initial position when are found closed the cold water and the hot water valves, will circulate current in the following components:

In the switches (Numbs. 11, 12, 34) without having change of state of these, also in the coil (Num.1) of its relay.

The switch (Num. 41) or (Num.23) FIG. 2 will be disconnected due to that is found closed the ball valve of the hot water for which will not circulate current in the coil (Num.15) of its relay.

In the coil (Num.1) will provoke change of state of the switches (Numbs. 2 and 3) connecting the coil (Num.7) of the relay, the coil (Num. 13) of the relay, the pull type solenoid (Num. 24) or (Num.62) FIG. 2. The coil (Num.2) of the relay will provoke a change of state in its switches, connecting the motor one (Num.29) or (Num. 65) FIG. 4.

When the button (Num.30) is maintained pressing goes to open completely the ball valve of the cold water (Num.2) FIG. 1 and it goes to drive the switch (Num.34) or (Num.21) of the FIG. 2, provoking a change of state, then will begin to open the ball valve of the hot water, as long as it does not exist changes in the switch (Num. 35) or (Num.22) FIG. 2.

The coil (Num.4) of its relay will activate the switches (Numbs.5 and 6) connecting the coil (Num.25) with the switch (Num.14) and these at the same time they will be connected with the motor (Num.29), or (Num.65) FIG. 4, as long as it does not exist changes of state in the switches (Numbs. 8, 9, and 14).

The coil (Num.15) of its relay will be connected with the switch (Num.41) while remain open the ball valve of the hot water. This coil (Num.15) of its relay will drive its switches (Numbs.16 and 17). When opening completely the valve (Num.1)(of the hot water) FIG. 1, will drive the switch (Num.35) provoking a change of state and connecting the green led (Num.32), the resistances (Numbs. 26 and 28) and the coil (Num.10) of its relay, with this the two ball valves are completely open. If it is continued pressing momentary pressure button (Num.30), the coil (Num.10) of its relay, will provoke a change of state in its internal switches (Numbs. 11 and 12) and it will connect the coils (Numbs. 13 and 7) of its relay and the pull type solenoid (Num.24), as long as the switch (Num.2) has not had change of state.

The coil (Num.7) of its relay will drive the switches (Numbs. 8 and 9) and it will connect the motor (Num.29) or (Num.65) FIG. 4, with this the valve (Num.2) FIG. 1 (of the cold water) will begin to close. If it is maintained pressing the button (Num.30) the valve (Num.2) FIG. 1 (of the cold water) will close completely and will drive the switch (Num.36), provoking thus a change of state in this and connecting to the red led (Num.33) and the resistances (Numbs. 26 and 28).

According go opening the valve (Num.2) FIG. 1 will be active (of the cold water) the switches (Num. 45) or (Num.68) FIG. 4, the resistances (Numbs. 26 and 28) and the yellow leds (Num.42) will be connected according go opening the valve (Num.2) FIG. 1 (of the cold water).

According go opening the valve (Num.1) FIG. 1 (of the hot water) the first switch that will activate will be the(Num.43) or (Num.71) FIG. 4, will connect the resistances (Numbs. 26 and 28) with the yellow led (Num.44) and later will continue being connected the switches (Num.40) or (Num.70) FIG. 4, the resistances will be connected (Numbs.26 and 28) and the yellow leds (Num.38), according go opening the valve (Num.1) FIG. 1 (of the hot water).

When pressing the momentary pressure button (Num.31), to begin to close the valve (Num.1) FIG. 1 (of the hot water), if is continued pressing the button (Num.31), the valve (Num.1) FIG. 1 (of the hot water) is completely closed and later will begin to close the valve (Num.2) FIG. 1 (of the cold water) until is completely closed.

In the case that is one of the two valves open (whether of the cold water and/or of the hot water), to the pressing the button (Num.31) will close them.

When the valves (Num.2) (of the cold water) and/or the valve (Num.1)(of the hot water) of the FIG. 1 are open and to the pressing the button (Num.31), first will begin to close the valve (Num.1)(of the hot water) of the FIG. 1, circulating current in the following components:

In the switches (Numbs.5,6,16 and 17) connecting the solenoid (Num.25) or (Num.61) FIG. 2 and the switch (Num.14), at the same time will connect the motor (Num.29) or (Num.65) FIG. 4, as long as has not had change of state in the switches mentioned, except the switches (Numbs.16 and 17) that will be driven by their coil (Num.15) of their relay.

After to have closed the valve (Num.1) FIG. 1 (of the hot water), the coil (Num.18) of its relay will be connected to the voltage (Num.39) as long as the switches (Numbs.3 and 36) has not had suffered change of state. The coil (Num.18) of its relay will provoke a change of state in its switch (Num.19) connecting thus the resistance (Num.27), the coil(Num.37) and the switch (Num.43), as long as the switch (Num.43) has not had suffered change of state.

The solenoid (Num.37) or (Num.24) FIG. 2 will provoke a contraelectromotive force in its bolt, that will pull to the switch lever (Num.41) or (Num.23) FIG. 2 through it metal sheet (Num.39) FIG. 2.

Since the valve (Num.1) FIG. 1 (of the hot water) was closed, when continuing pressing the button (Num.31) it will begin to close the valve (Num.2) FIG. 1 (of the cold water), the coil (Num.15) of its relay will be disconnected and its switches (Numbs.16 and 17) will be deactivate, returning to its initial position due to that its coil (Num.15) of its relay will be disconnected, connecting the coil (Num.7) of its relay, the coil (Num.13) of its relay and the pull type solenoid (Num.24) or (Num.62) FIG. 2.

The coil (Num.7) of its relay will activate its switches (Numbs. 8 and 9), connecting the motor (Num.29) or (Num.65) FIG. 4, this will begin to close the valve (Num.2) FIG. 1 (of the cold water), when continuing pressing the button (Num.31), until is completely closed, will be driven the switch (Num.36), connecting the red led (Num.33) and the resistances (Numbs. 26 and 28).

If only it is open the valve (Num.1)FIG. 1 (of the hot water), when pressing the button (Num.31) will begin to close this valve, circulating current in the following components:

In the switches (Numbs. 5,6,16 and 17) connecting the pull type solenoid (Num.25) or (Num.61) FIG. 2 and the switch (Num.14), at the same time will connect the motor (Num.29) or (Num.65) FIG. 4, as long as has not had change of state in the switches mentioned, except the switches (Numbs.16 and 17) that will be driven by their coil (Num.15) of the relay.

If only it is open the valve (Num.2) FIG. 1 (of the cold water), will pressing the button (Num.31), will begin to close this valve, then will circulate current through the following components:

The switches (Numbs. 16 and 17) of the coil (Num.15) of its relay, as long as has not suffered change, will be connected the coil (Num. 7) of its relay, the coil (Num.13) of its relay and the solenoid (Num.24) or (Num.62) FIG. 2.

The coil (Num.7) of its relay will activate its internal switches (Numbs.8 and 9), connecting the motor(Num.29) or (Num.65) FIG. 4, which will begin to close the valve (Num.2) FIG. 1 (of the cold water), when continuing pressing the button (Num.31), until is completely closed, will be driven the switch (Num. 36), connecting the red led (Num.33) and the resistances (Numbs. 26 and 28).

Timer:

Through the switch (Num.16) that will be activated by its coil (Num.15) of its relay the east switch (Num.16) will connect to the timer (Num.23), the capacitor (Num.22) and the coil (Num.20) of its relay and activating its internal switch (Num.21) depending on the time programmed by the timer, the switch (Num.21) complies with its function that is to close first the ball valve (Num.1) FIG. 1 (of the hot water) and upon being closed this, the switches (Numbs. 16 and 17) will deactivate, due to that the coil (Num.15) of its relay will be disconnected because the switch (Num.41) or (Num.23) FIG. 2 that will be activated, for this the switch (Num.21) will remain closed and will close the valve (Num.2) FIG. 1 (of the cold water).

The quantity of switches(Numbs. 40,43 and 45) and the leds (Numbs. 38, 42, 44, 32,33) can vary depending on the scale that be established in the digital button control.

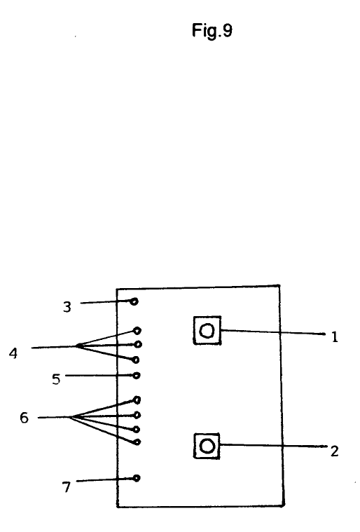

FIG. 9. Button Control.

This control is connected to the circuit of the FIG. 8. The momentary contact button (Num.1) or (Num.30) FIG. 8 is to open, whether the valve (Num.1) FIG. 1 (of the hot water) or the valve (Num.2) FIG. 1 (of the cold water), the momentary contact button (Num.2) or (Num.31) FIG. 8 will be to close the valve (Num.1) FIG. 1 (of the hot water) and/or valve (Num.2) FIG. 1 (of the cold water).

The green led (Num.3) or (Num.32) of the FIG. 8, will indicate that is completely open the valve (Num.1) FIG. 1 (of the hot water).

The red led (Num.7) or (Num.33) of the FIG. 8, will indicate that is completely closed the valve (Num.2) FIG. 1 (of the cold water).

The yellow leds (Num.6) or (Num.42) FIG. 8 they are the scale that indicates gradually the opening of the ball valve (Num.2) FIG. 1 (of the cold water).

The yellow led (Num.5) or (Num.44) FIG. 8 is the first one that is active when the ball valve (Num.1) FIG. 1 (of the hot water) begins to open.

The yellow leds (Num. 4) or (Num.38) FIG. 8 are the scale that indicates gradually the opening of the ball valve (Num.1) FIG. 1 (of the hot water).

C). Variable Faucet of Flow of 2 Valves with Intelligent Control to Remote Control.

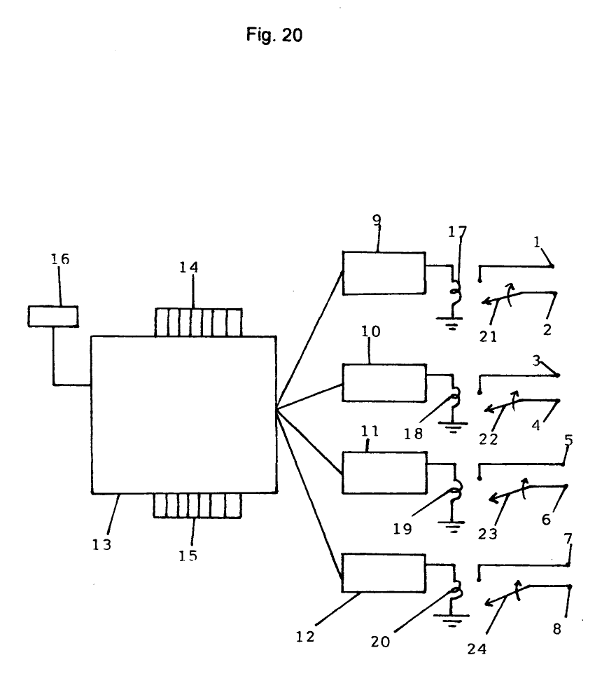

FIG. 20 Diagram of Blocks of the Intelligent Control Receiving.

This diagram is composed of:

The relay (Num.17) with its switch (Num.21) of 1 contact.

The relay (Num.18) with its switch (Num.22) of 1 contact.

The relay (Num.19) with its switch (Num.23) of 1 contact.

The relay (Num.20) with its switch (Num.24) of 1 contact.

The filters (Numbs. 9, 10,11 and 12).

The modulo receiving (Num.13).

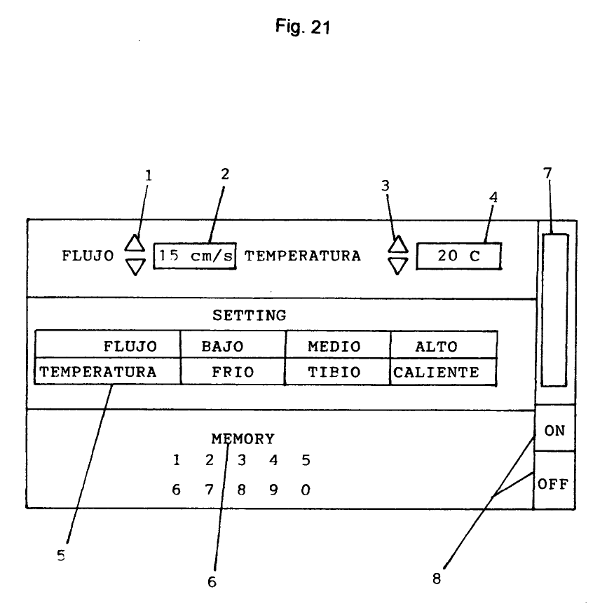

Connection (Num.14) to the intelligent control FIGS. 21.

Connection to the flow and temperature (Num. 15) sensors.

Frequency radio antenna or beam of light sensor or infrared rays of frequency reception (Num.16).

The points (Numbs.1 and 2) will be connected to the points (Numbs. 50 and 51) FIG. 5 eliminating the momentary button (Num.14) FIG. 5.

The points (Numbs.3 and 4) will be connected to the points (Numbs. 52 and 53) FIG. 5 eliminating the momentary button (Num.15) FIG. 5.

The points (Numbs.5 and 6) will be connected to the points (Numbs. 54 and 55) FIG. 5 eliminating the momentary button (Num.16) FIG. 5.

The points (Numbs.7 and 8) will be connected to the points (Numbs. 56 and 57) FIG. 5 eliminating the momentary button (Num.17) FIG. 5.

The module receiving (Num.13) receives the signals of the intelligent control FIGS. 21 through the connections (Num.14) or reception of frequency of the remote control (Num.16), so that this modulo execute the function or functions that have been given to the intelligent control FIGS. 21. Will store the conditions that are established for the user in its internal memory.

The module receiving (Num.13) sent signals to the different filters (Numbs. 9,10,11, and 12) activating its respective relays according to the filter or filters that the module have elected; thus the switch or switches of these relays will be activated doing contact with the respective points of the FIG. 5, and thus will activate the circuit of this figure.

The sensors will give the information of flow and temperature to the module through the connection (Num.15), thus this module will carry out adjust them through the filters according to the temperature and flow that the intelligent control has ordered it FIG. 21, sending a BEEP when it has reached.

FIG. 21. Intelligent Control Receiving or Transmitting.

The functions of the control are:

Flow of water.—Is comprised of two button selectors (Num.1) to establish the flow of water desired showing the reading in the display (Num.2).

Temperature of Water.—Is comprised of two button selectors (Num.3) to establish the temperature of water desired, showing the reading in the display (Num.4). Flow and Temperature Selector (SETTINGS) (Num.5).—The user has the option of choosing the flow of LOW, MEDIUM OR HIGH and the temperature already established of COLD, WARM OR HOT.

Memory (Num.6).—Its function is to store with a number given, the flow and the temperature to the user desire, using the digits or numbers of the control.

Indicator (Num.7).—Will produce a BEEP and will be illuminated indicating that has reached the conditions of flow and temperature desired.

ON-OFF (Num.8).—When has the flow and the temperature established, after to have listened the BEEP and has been illuminated the indicator (Num.7) the faucet will be opened with only to activate the function ON and the water will be supplied. The faucet will close with the function OFF or will close automatically by to have completed with the time established by the automatic closed.

The functions are going to be the same for the receiving like for the transmitting, for this the dial of the transmitting or receiving will be the same. The buttons that are utilized for the different functions are of pressure or presence, being these last one activated only with put the finger upon the button.

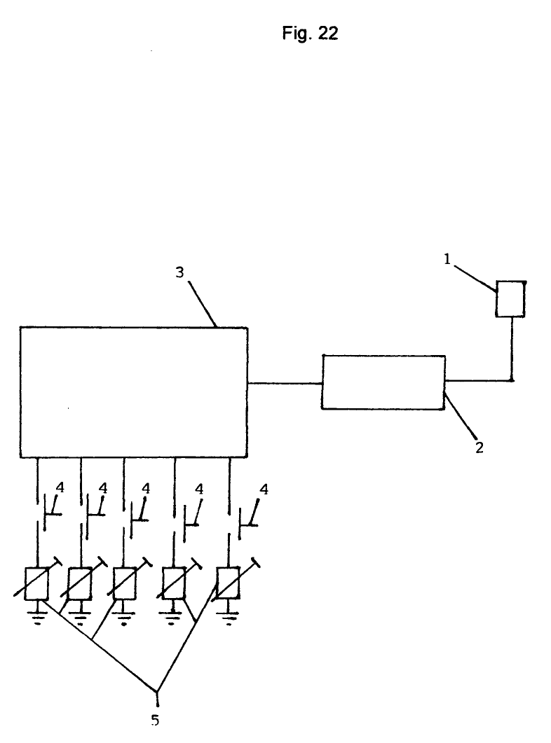

FIG. 22. Schematic Circuit.

Blocks Diagram of the Intelligent Control Transmitting.—This diagram is composed of:

Frequency Transmitter (Num.1), Beam of Light, or Infrared Rays or Radio Frequency.

Oscillator of Frequency (Num.2).

Channels (Num.4).

Adjustments (Num.5).

When pressing any button (Num.4) will drive the channels or button, giving the order to the oscillator of modulation about the function that should carry out, this modulo will send the final signal to the frequency oscillator and this will become in frequency, in radio frequency, beam of light or infrared ray, sending it through the transmitter of frequency (Num. 1).

d). Variable Faucet of Flow of 2 Valves with Voice System.

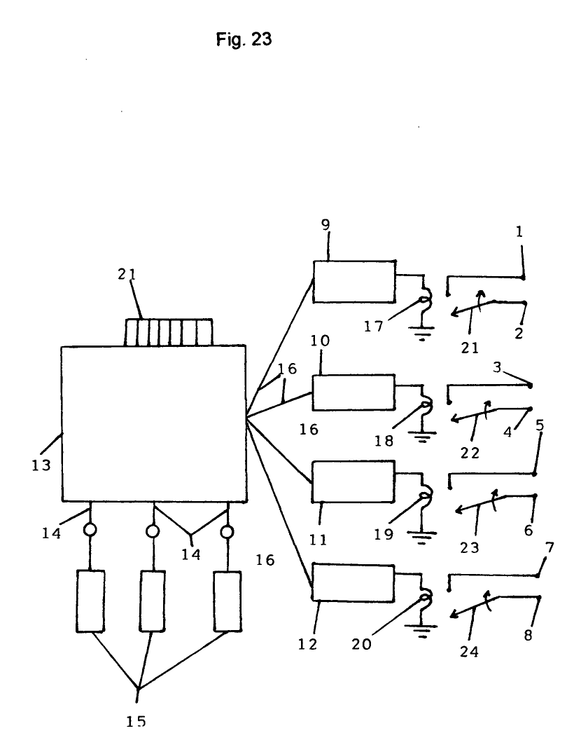

FIG. 23 Diagram of Blocks of the Control with Voice System.

This diagram is comprised of:

The relay (Num.17) with its switch (Num.21) of 1 contact.

The relay (Num.18) with its switch (Num.22) of 1 contact.

The relay (Num.19) with its switch (Num.23) of 1 contact.

The relay (Num.20) with its switch (Num.24) of 1 contact.

The Filters (Numbs. 9,10,11y 12).

Main module (Num.13).

Connections (Num.14) to the voice sensors (Num.15).

Connections (Num.16) of the main module (Num.13) to the filters (Numbs.9,10,11 and 12).

The points (Numbs. 1 and 2) will be connected to the points (Numbs. 50 and 51) FIG. 5 eliminating the momentary button (Num.14) FIG. 5.

The points (Numbs. 3 and 4) will be connected to the points (Numbs. 52 and 53) FIG. 5 eliminating the momentary button (Num.15) FIG. 5.

The points (Numbs. 5 and 6) will be connected to the points (Numbs. 54 and 55) FIG. 5 eliminating the momentary button (Num.16) FIG. 5.

The points (Numbs. 7 and 8) will be connected to the points (Numbs. 56 and 57) FIG. 5 eliminating the momentary button (Num.17) FIG. 5.

Connection (Num.21) to the sensors of flow and temperature.

The main module (Num.13) receives the order signals by the voice sensors (Num.15), so that this module execute the conditions established through the voice, also store in its internal memory any condition that the user thus desire it.

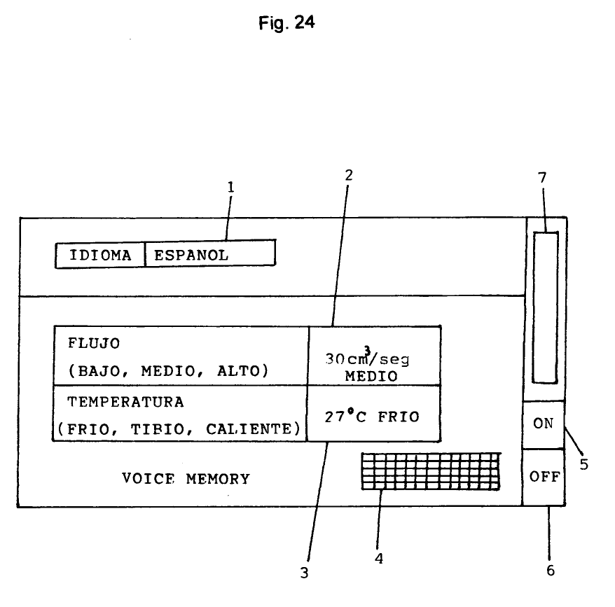

The manner of carrying out the functions for the temperature control and flow are through key words that are assigned by the manufacturer and the user, that they will be described in the FIG. 24.

The main module (Num.13) will send signals to the different filters (Numbs. 9,10,11 and 12) activating its respective relays according to the filter or filters that the module have elected; by which will activate, doing contact the switch or switches, of these relays with the respective points of the FIG. 5, and thus will activate the circuit of this figure.

The sensors will give the information of flow and temperature, to the main module (Num.13) through the connection (Num.21), thus the module will carry out adjustment through the filters according to the flow and temperature that the user through its voice has ordered it, that is received for the sensors of voice.

FIG. 24 Control with Voice System.

The functions that the control consist will be driven with the voice they are:

Display (Num.1) where will indicate the LANGUAGE (English, Spanish, etc.)

Display (Num.2) will indicate the FLOW (Low, Medium, High) and/or pressure (cm3/seg, m3/seg, etc.) desired.

Display (Num.3) will indicate the TEMPERATURE (Cold, Warm, Hot) and/or the temperature in degrees (Centigrade, Fahrenheit, etc).

Memory of voice (Num.4) (VOICE MEMORY). where this control will receive the voice to carry out its function of storing in its internal memory with a name that establishes the user to each condition of Flow and Temperature desired, thus each name given to each condition established by the user, will be stored in the corresponding memory.

Display (Num.5).—When the user through the voice has established the Flow and the Temperature and the indicator (Num.7) be illuminated, then the user will give the Order of ABRIR, ON, etc., and will appear in the display (Num.5) according to the chosen language. The display (Num.5) will not be able to be driven manually in ON.

Display (Num.6).—This display will help to close the faucet, receiving the voice order of Closing, OFF, etc., according to the chosen language or pressing this display to close the faucet in normal conditions or in cases of emergency, appearing in display the word of CERRAR, OFF, etc., according to the language that him have elected.

Indicator (Num.7) will give a BEEP and will be illuminated, this will indicate that has reached the conditions of flow and temperature desired.

In order to operate this control the user will activate it through voice orders, choosing primarily the language, which after the order will appear in display, then the flow and the temperature, choosing the conditions previously established or indicating specifically a quantity In flow and temperature. Another option is to mention the name of the condition previously stored in the voice memory.

After to have defined these parameters will listen a BEEP and will be illuminated the indicator, when such condition has been reached, the user at this time will give the order of ABRIR, ON, etc., according to the language of it selection, and the water will be supplied. The faucet has a automatic closed, as be the time defined by the manufacturer or the user so that the faucet be closed, and thus the faucet will close.

If the user requires to close the faucet before the time of the automatic closing, will be able to give the order of CERRAR, OFF, etc., through the voice according to the language of his selection, or pressing the display (Num.6).

2. Digital Faucet of Variable Flow of 1 Valve.

a). Digital Faucet of Variable Flow of 1 Valve with Control of 2 button.

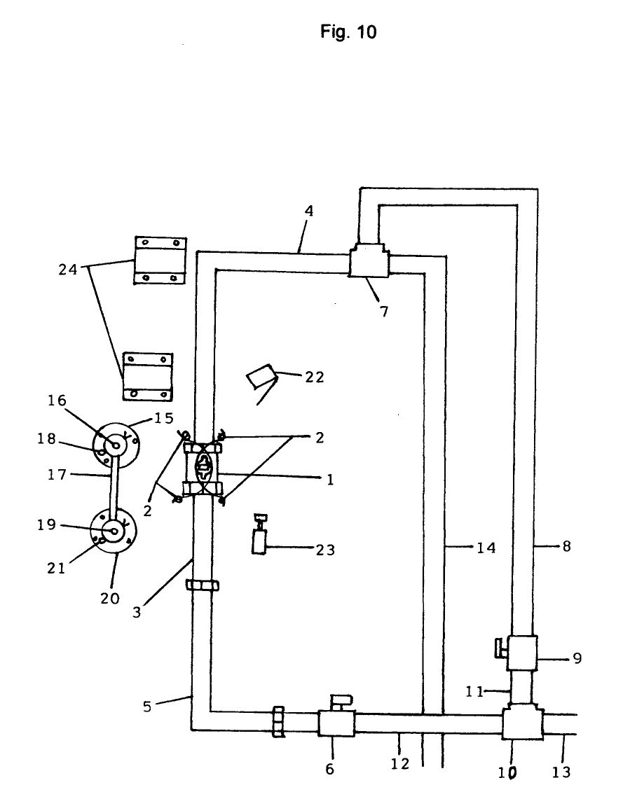

FIG. 10 Connections, Supports and Axes of Gear.

A ball valve (Num.1) is fixed in their base or drawer with belts (Num.2) or with a metal sheet welded to the valve in their base, 2 tubes are connected (Numbs. 3 and 4) in the extremes of the ball valve.

The tube (Num.3) is connected to the hose (Num.5) and this hose is connected to the pass valve (Num.6). In the other extreme of the tube (Num.4) is connected a “T” (Num.7), where joins with the valve of security (Num. 9), through a tube (Num.8) and this valve of security (Num.9) will join with another connector type “T” (Num.10) through the tube (Num.11). In the two extremes of the connector type “T” (Num. 10) that have not been united, one of these extremes is connected through the tube (Num.12) to the pass valve (Num.6), by the other extreme of the connector type “T” (Num.10) is connected to the takes (Num.13) of liquids, gases and/or pulverized solids. The connector type “T” (Num.7) in the extreme that has not been connected, joins with the tube (Num.14) of supply of liquids and/or gases.

The base (Num.15) is fixed, to this one is welded perpendicularly in its center a bolt (Num.16), to this bolt is inserted the bolt (Num.17) through its ring that is in its extreme, under the ring a cotter pin (Num.18) is inserted in the bolt (Num.16), which allow that the bolt (Num.17) not slide downward. In the other extreme of the bolt (Num.17) carries another ring in which the bolt (Num.19) is inserted, this go united to the base (Num.20). In its lower extreme of the ring of the bolt (Num.17) carries a cotter pin (Num.21) that is inserted in the bolt (Num.19), this cotter pin allow that the bolt (Num.17) not slide the downward.

Next to the ball valve (Num.1) as indicates the figure, the switches lever (Numbs. 22 and 23) are set.

The bases (Num.24) is held to the motor, they are located approximately near the connection type “T” as is shown in the figure.

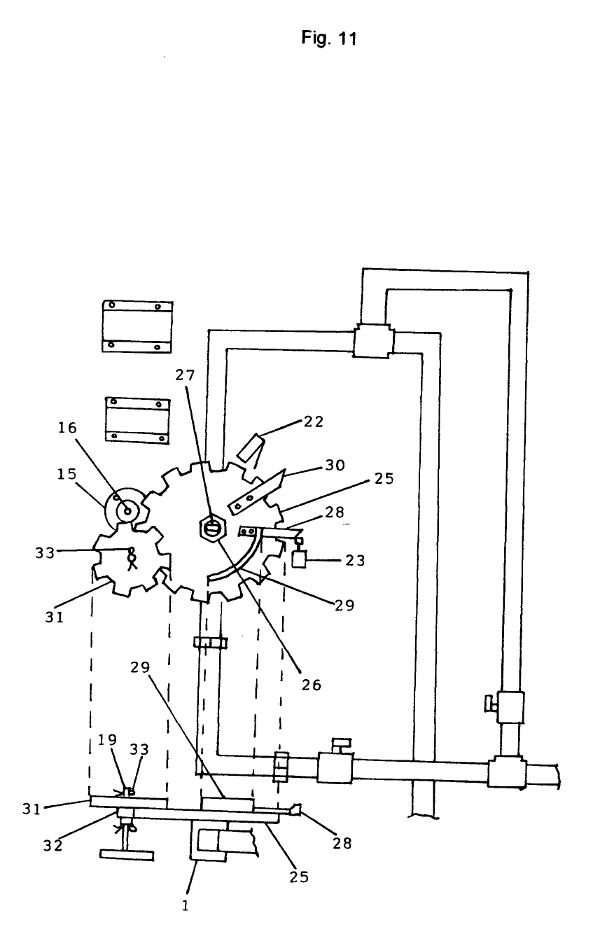

FIG. 11. Assembly and Operation of Gear.

It is required a gear (Num.25) which is previously grooved in its center to the offspring (Num.27) dimension of the of the ball valve. The gear (Num.25) is inserted and is held with a nut (Num.26) to the offspring (Num.27) of the ball valve (Num.1) FIG. 10. In the upper part of the gear (Num.25) are set 3 metal sheet (Numbs. 28, 29, and 30). The horizontal metal sheet (Num.28) has a fold in its salient extreme of the gear whose function is to drive the lever switch (Num.23) when the ball valve is closed, or to drive the lever switch (Num.22) when the ball valve is completely opened, The metal sheet (Num.29) is fixed upon to metal sheet (Num.28), this metal sheet is vertical with a curvature according to the gear (Num. 25) curvature.

In order to allow to vary the maximum opening for the supply, it can be installed the metal sheet (Num.30) separated of it metal sheet (Num. 28) in the gear (Num.25) to a distance that permits to move in a rank the metal sheet until setting the opening desired of the ball valve (Num.1) FIG. 10, another option is to vary the position of the lever switch (Num.22) with regard to the lever switch (Num.23), obtaining also thus to set the maximum opening of the ball valve.

The gear (Num.31) carries united in their center a small one gear (Num.32), which are inserted in the bolt (Num.19). In the superior part of this bolt is inserted a cotter pin (Num.33), with the purpose that the gears(Numbs.31 and 32) do not leave.

In this figure a frontal view of the relations of gears is shown.

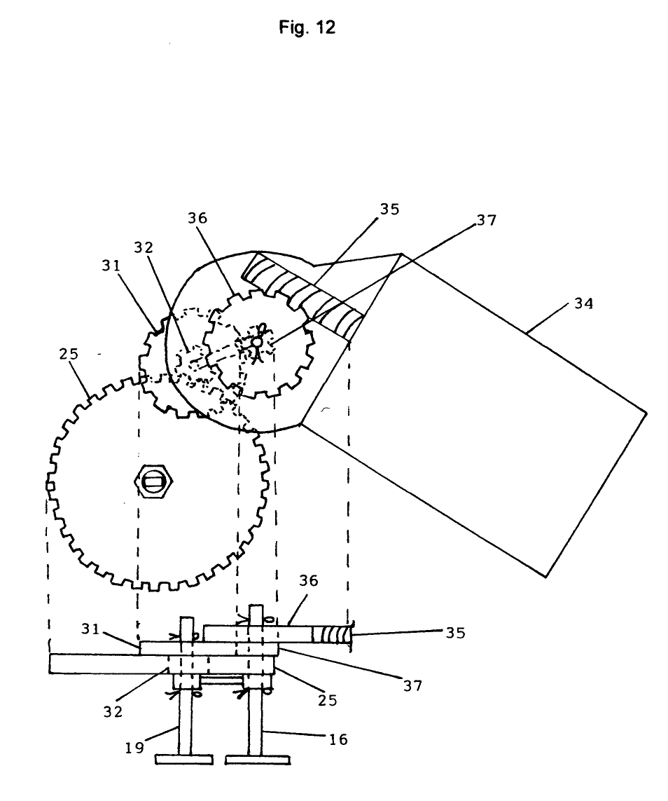

FIG. 12. Connection of the Gear with the Motor.

Upon activating the motor (Num.34) that has an arrangement of the gear of screw (Num.35) that is the axis of the motor, the screw rotates in sense of the polarity of the voltage that is applied it, this screw will be engage with the gear (Num.36), which will move it, and this at the same time will move the gear (Num.37) that is united to its center. The gear (Num.37) will be always meshed with the gear (Num.31). The gear (Num.32) goes united to the center of the gear (Num.31), will provoke movement in the gear (Num.25) that will open or will close the ball valve (Num.1) FIG. 10, depending of the direction of motor rotation (Num.1) FIG. 10.

In this figure a frontal view of the relations of the gears with the motor is shown.

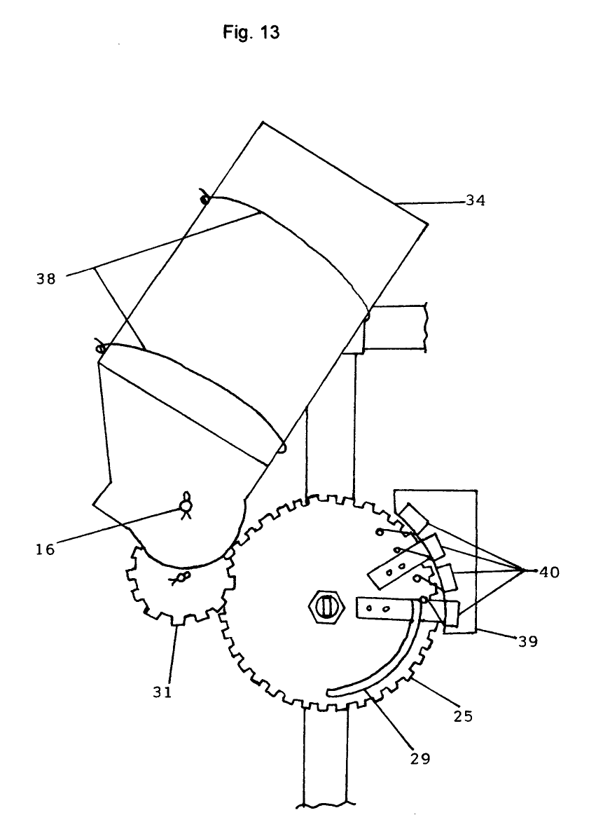

FIG. 13. The Motor and Switches Assembly.

The motor (Num.34) is assembled through the orifice of the gear (Num.37) FIG. 12, in the bolt (Num.16) FIG. 11, FIG. 12 or in this figure, in the other extreme of the motor is held through belts (Num.38) to the bases (Num.24) FIG. 10.

Among the lever switches (Numbs.22 and 23) FIG. 11, to the superior part of these are fixed a curved metal sheet (Num.39), the lever switches(Num.40) are set to activate the yellow leds to indicate the opening of the ball valve. When the gear (Num.25) rotates against of the will go driving the switches (Num.40) through it metal sheet (Num.29) to the extent that go opening the ball valve (Num. 1) FIG. 10, and if it rotates against of the will become inactivate the lever switches (Num.40).

In the FIG. 10, FIG. 11, FIG. 12 and FIG. 13 is maintained the same number assignalsed in each one of the parts, depending if in the figure the part is shown. Since the description of the FIG. 10, FIG. 11, FIG. 12 and FIG. 13 is established the sequence of joining of the electromechanical system of control.

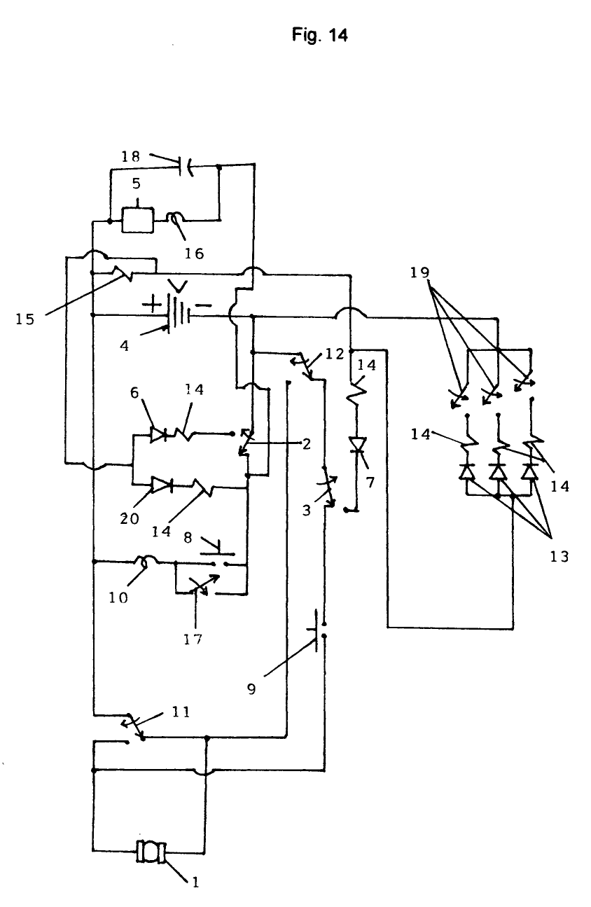

FIG. 14. Electronic Circuit.

The electronic circuit is comprised of the following components:

Motor (Num.1) or (Num.34) FIG. 13.

Lever switch (Num.2) or (Num. 23) FIG. 11.

Lever switch (Num.3) or (Num.22) FIG. 11.

Voltage (Num.4). Timer (Num.5). Red led (Num.6).

Green led (Num.7).

Momentary contact button to close (Num.8)

Momentary contact button to open (Num.9).

Coil (Num.10) of the relay of 2 switches of 2 contacts each one (Numbs. 11 and 12).

Yellow leds (Num. 13).

Resistances (Numbs. 14 and 15).

Coil (Num.16) of the relay of 1 switch (Num.17) of 1 contact.

Capacitor (Num. 18).

Lever Switches (Num.19) or (Num.40) FIG. 13 of activation of the yellow leds.

First yellow led (Num.20) active when the valve is opened.

When pressing the momentary contact button (Num.9) to open the ball valve (Num.1) FIG. 10, will circulate current in the following components:

In the switches (Numbs.3, 11 and 12) without having change of state in these, thus will connect to the motor (Num.1) or (Num.34) FIG. 13, and will go opening the ball valve.

To the pressing the momentary contact button (Num.8) to close the ball valve (Num.1) FIG. 10, will circulate current, as long as does not have change of state the switch (Num.2), in the following components:

By the coil (Num.10) of the relay, driving its switches (Numbs. 11 and 12) and these at the same time they will connect to the motor (Num.1) or (Num.34) FIG. 13, and thus will go closing the ball valve.

By the led (Num.20) and the resistance (Num.14), to the extent that go opening the ball valve will be activated first this led. Later the switches (Num.19) they will go driving provoking the passage of current to the resistances (Num.14) and the leds (Num.13).

Being the ball valve completely closed, will be driving the lever switch (Num.2) circulating current through the resistance (Num.14) and the led (Num.6), reason why will be illuminated and indicating that is found close the ball valve.

Being the ball valve completely opened will be driven the lever switch (Num. 3), circulating current through the resistance (Num.14) and the led (Num.7), reason why will be illuminated and indicating that is found open the ball valve.

Timer:

The capacitor (Num.18), the timer (Num.5) and the coil (Num.16) of the relay, through these will circulate current, as long as the switch (Num.2) or (Num.23) FIG. 11 does not is activated, that is to say that ball valve is opened.

The coil (Num.16) of the relay will drive its switch (Num.17), depending on the time programmed by the timer, for which the switch (Num.17) complies with the function of closing the ball valve.

The quantity of switches (Num. 19) and the leds (Numbs. 20, 6, 13 and 7) can vary depending of the scale that is established.

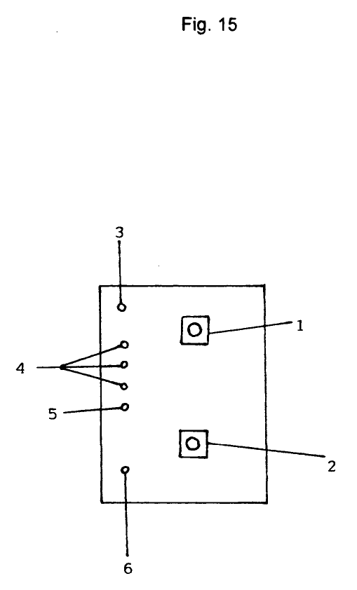

FIG. 15. Button Control.

This control is connected to the circuit of the FIG. 14. The momentary contact button (Num.1) or (Num.9) FIG. 14 is for opening, and the The momentary contact button (Num.2) or (Num.8) is for closing the ball valve. The Green led (Num.3) or (Num.7) FIG. 14, will indicate that is found open completely the ball valve.

The Red led (Num.6) of this figure or (Num.6) FIG. 14, will indicate that is found close completely the ball valve.

The Yellow led (Num.5) or (Num.20) FIG. 14, is the first one that is actived when the ball valve begins to open. The Yellow leds (Num.4) or (Num.13) FIG. 14 are the scale that indicates the gradual opening of the ball valve.

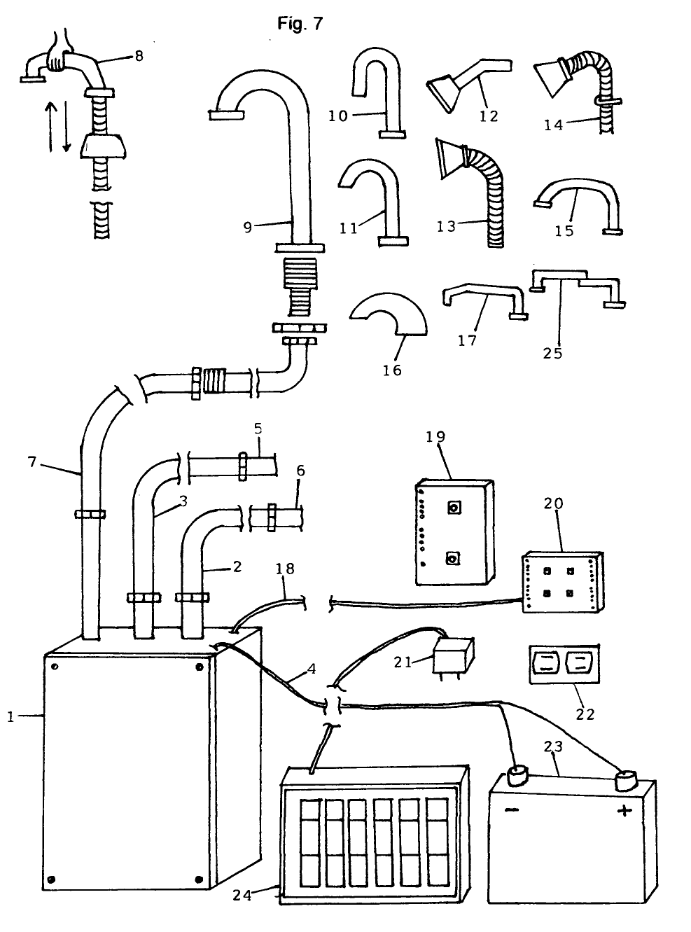

FIG. 7. Installation.

1. For the installation of the electromechanical control system (Num. 1) can be set or to be interlocked in the wall, or another support or furniture, or any other way of subjection.

2. 2 hoses are connected (Numbs. 2 and 3) to the taking (Num.5) (of the cold water) and to the taking (Num.6) (of the hot water). In the case of one ball valve will be only connected to a single taking. The hose (Num.7) of supply can be connected to different types of tubes (Numbs. 8, 9, 10, 11, 12, 13, 14, 15, 16, 17 and 25) or other water supplier tubes as showers, sinks, lavatories, jacuzzi, bathtube etc., as the figure shows.

Also it can be installed to the water supplier tube (Num.8) that is “pull up” type permitting to pull the tube to the length that be required and subsequently to return to its original position. The hoses can be connected also to another type of liquids and/or gases.

3. Controls.

The wires assembly (Num.18) can be connected to the different types of receiving controls of 2 button (Num.19) or of 4 button (Num.20), intelligent control or to remote control (Num.21) or voice system (Num.24).

The wire (Num.4) is of the voltage of direct current that can be connected to a voltage converter (Num.21) of alternate to direct current and this at the same time is connected to the voltage taking of alternate current (Num.22).

The wire (Num.4) can also be connected to one or to several batteries (Num.23) according to the voltage required, to solar cells (Num.24) or another type of source that voltage of direct current generates.

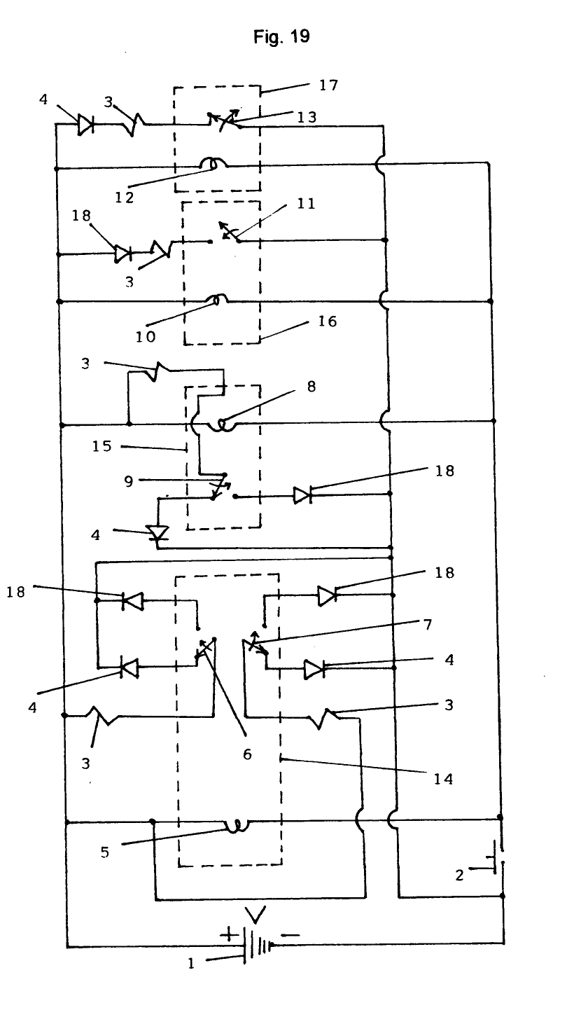

FIG. 19. Electronic Circuit of the Universal Tester for Relays.

Is comprised of the following components:

Voltage (Num.1).

Resistances (Num.3).

Led indicator (Num.4, 18).

The socket (Num.14) for the relay of its coil (Num.5) and its switches (Num.6 and 7) of 2 contacts each one.

The socket (Num.15) for the relay of its coil (Num.8) and its switch (Num.9) of 2 contacts.

The socket (Num.16) for the relay of its coil (Num.10) and its switch (Num.11) of 1 contact.

The socket (Num.17) for the relay of its coil (Num.12) and its switch (Num.13) of 1 contact.

In this diagram is shown with doted square a the different types of relays (Numbs.14, 15, 16 and 17) where can be placed in the socket corresponding to verify its operation.

When pressing the momentary pressure button (Num.2) will drive the coil or coils of the relay or relays that have been placed, provoking that be driven the switches internal to thus test their operation and the leds will be the ones that indicate that switches are doing contact.

Claryfication Notes:

The intersection among lines curves and straight indicated in the FIG. 5, FIG. 8 and FIG. 14 do not represent connections in the circuit, and the intersections with points that indicate connections. The switches they are known also as miniature switches of instant action. The DIGITAL FAUCET types the different thing application OF VARIABLE FLOW can be liquids and/or gases mixed or without mixing.

Any control, can be integrated upon the different types of outlet tube as part of these.

The Digital Faucet of Variable Flow also can be operated through the following mass media: via Internet, telephone, cellular telephone or systems of programming.

Sustitution.

OPTIONS FOR PARTS THAT CAN BE SUBSTITUTED IN THE DIFFERENT MOOF THES OF THE DIGITAL FAUCET OF VARIABLE FLOW. FIG. 3 and FIG. 12 can be substituted the screw without end (Num.64) and (Num.35) by a gear for which the motor can go in different position. FIG. 4 and FIG. 13 the quantity of switches miniature of instant action (Numbs.68, 70 and 71) and (Num.40) respectively, they can vary relating to the indicating scale a that be established in the control. In the button control the quantity of leds can vary, FIG. 9 Leds (Numbs.3, 4, 5, 6, and 7), FIG. 15 leds (Numbs.3, 4,5 and 6), FIG. 6 (Numbs. 5,6,7,8,9,10,11 and 12) respectively depending on the indicating scale a that be established; in the same way the leds can be of different color and quantity. This scale can also be of another type of material as display, liquid crystal, etc. The Button they can be substituted for another type.

In the FIG. 2 and FIG. 11 can be done other distribution of tubes, hoses, faucets connections, etc., whenever the relation of the design be maintained. The button of momentary contact in the button control they can be substituted for any another type of contact or switch.

### EXAMPLE OF APLICACION

Subsequently examples of the application they are shown and installation of the DIGITAL FAUCET OF VARIABLE FLOW:

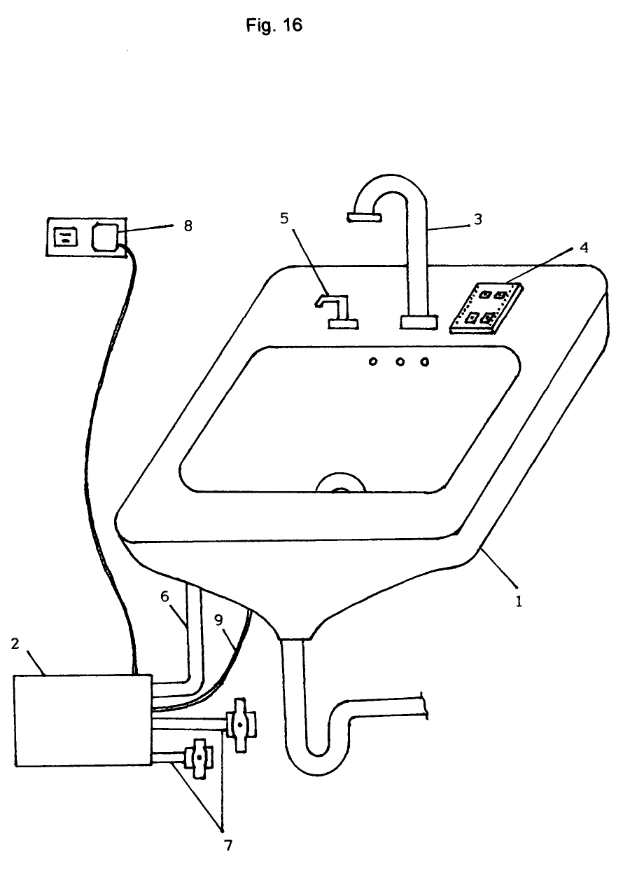

FIG. 16. In Lavatory.

Upon being installed the digital faucet in the lavatory and upon driving for the user the control (Num.4) (which can be any type of control before described), the electromechanical system (Num.2) will receive the signals through the wire (Num.9), thus the Internal valves of the electromechanical system will be opened or closed as be the election of the user, then the water mixed or without mixing will be supped for the provision tube (Num.6) until arrive at the outlet tube (Num.3).

The system of electromechanical control (Num.2) will be supplied of water of the hoses (Num.7) that are connected to taking of the hot and cold water. This electromechanical system (Num.2) will be fed for the source of current (Num.8) (Voltage converter) and this at the same time will supply of voltage to the digital control (Num.4) according to the voltages handled by this of electromechanical control system (Num.2).

Notes: Upon remaining an available drilling in the lavatories, permits to place the soap liquid dispenser (Num.5).

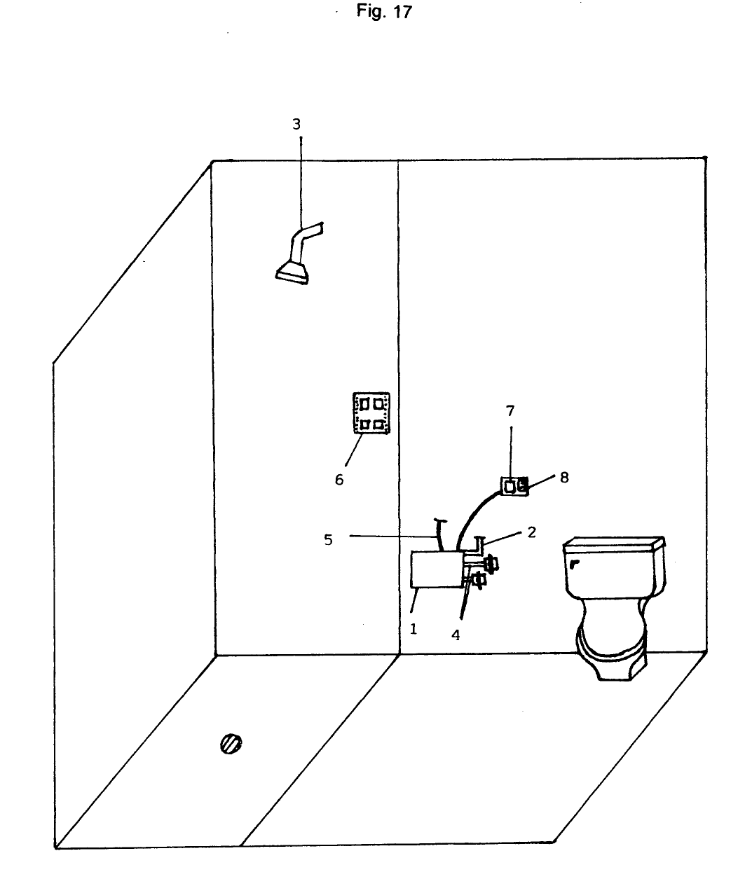

FIG. 17. In Shower.

Upon being installed the digital faucet in the shower and upon driving the digital control (Num.6) by the user (this control can be any type of control before described), the electromechanical system (Num.1), will receive the signals through the wire (Num.5), thus the internal valves of the electromechanical system (Num.1) will be opened or closed as be the election of the user, the water mixed or without mixing will be supplied for the tube (Num.2) until arrive at the outlet tube (Num.3).

The electromechanical control system (Num.1) will be supplied of water of the hoses (Num4) that they are connected to the taking of hot and cold water. The electromechanical system (Num.1) will be fed for the source of current (Num.7) (Converter of voltage), and this at the same time will supply of voltage to the digital control (Num.6) according to the voltages handled by this electromechanical system (Num.1).

Advantages of the Digital Faucet of Variable Flow.

1. This DIGITAL FAUCET OF VARIABLE FLOW, by its digital and compact designs comes to revolutionize its use in lavatories, sinks, jacuzzi, bathtube, showers, etc., thus giving to the user the comfort and the innovation in home, business, hospitals, restaurants, etc., of same way to facilitate the use for children and person with physical disability

2. The DIGITAL FAUCET OF VARIABLE FLOW facilitates the installation, and since it does not requires the mixer faucet of offspring with plunger (or nother type of mixer faucet), an example of these typical faucets is shown in:

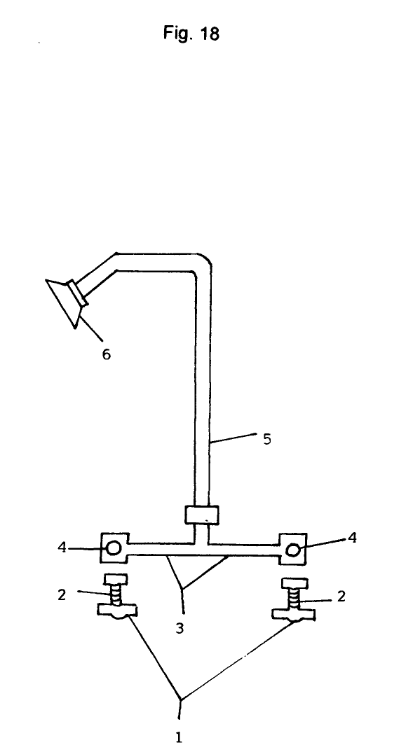

FIG. 18. In Showers.

Is comprised of the following components:

Knobs or handle (Num.1).

Plunger and offspring (Num.2).

Mixer (Num.3).

Plunger seat and cold or hot water (Num.4) taking.

Tube of provision (Num.5).

Shower (Num.6).

Upon rotating the knobs (Num.1) will move to the offspring and the plunger corresponding provoking that be opened or be closed the outlet (Num.4) corresponding of the cold or hot water, permitting that the water flow by the mixer (Num.3) provoking the mixture of the water, which will flow for the tube (Num.5) until the water is supplied by the shower (Num.6).

For the installation, repair or reposition of some piece of the faucet completely is required to groove and to embed in the wall, so The DIGITAL FAUCET OF VARIABLE FLOW does not require to embed in the wall; in lavatories and sinks, etc., does not require of retiring the furniture for the installation, since only is required for its installation a outlet tube (of the water) and a control that substitute the conventional mixer faucets in the furniture.

3. It is easy to understand the use of the digital control, fixed intelligent control or to remote control or voice system.

A manual effort is not required to open or to close the faucet, due to that to carry out this operation is required only the most minimum pressure upon the button desired in the case of the digital control.

4. Given that in the digital control are found concentrated the operations of opening and closing of the cold and hot water doing quicker its mixture, since is found to less distance in comparison to the conventional faucets.

5. In the handling of DIGITAL FAUCET OF VARIABLE FLOW the area of use in the furniture is maintained cleaner (examples: lavatories, showers, sinks, etc.) given to the most minimum pressure of a finger or another middle in the button of the digital control to open or to close the valves will be driven, however the conventional faucets are required to use the complete hand and the distance between knobs is ample provoking that the area of use be greater and consequently a greater dirty area due to the water, soap, furry encrustation, etc.

6. It permits to vary in digital way, to remote control or with the voice system the volume of the flow and the temperature of the water supplied.

7. It is comprised of a Timer which helps to close the valve or valves automatically in a time interval determined, programmed according to the needs of the user, to assure that the faucet or faucets are closed, avoiding thus the waste of water if remained some one opened by accident, carelessness, badly state of the faucets etc.

8. As opposed to the conventional faucets offers the options of using digital control, remote control or voice system, for a variable flow and temperature, and automatic closed.

9. In comparison with the faucets of sensor, these consume energy during the pass of the flow of water, on the other hand the DIGITAL FAUCET OF VARIABLE FLOW only consumes energy at the moment that is pressed the button and is driven the Timer, for this the expense of energy is smaller than the sensor faucet.

10. The DIGITAL FAUCET OF VARIABLE FLOW that contains ball valves has less wearing downs than the faucets of offspring with plunger, which makes more durable in comparison to these.

11. The box of the control electromechanical can be disconnected easily to be carried to a work table for its maintenance or repair, given this is not required of moving or to work upon the furniture whether sink, lavatory, shower, etc.

In the case of requiring any piece of the DIGITAL FAUCET OF VARIABLE FLOW is easy acquiring it in the market and to the same way for its reposition.

12. Another of the Advantages of the DIGITAL FAUCET OF VARIABLE FLOW is that contains an accessory that is the Universal Tester Of Relays, which permits to test the relays of the electronic circuit and to detect those that not are functioning, in this way the user will be saving of this repair will be carried out for technical personal.

13. As a security system for in case of some fault of electric energy the DIGITAL FAUCET OF VARIABLE FLOW has a battery.

For the effects set forth in rule 6.3, section a) subsection i) of the PCT Regulations, I seek the protection of a Digital Faucet of Variable Flow that controls, from a fixed or remote control, through digital or voice commands the opening of the valves, flow, flow progressiveness, mixture and timing of liquids, gases and/or pulverized solids, manually or by programming such settings at the user's personal preference. Therefore, I seek the protection, as my exclusive property and invention, of the following claims

1. DIGITAL FAUCET OF VARIABLE FLOW with the characteristics that allow the user to activate through commands the opening and closing of the valve or valves, and to control the stream, flow progressiveness, mixture and timing of liquids, gases and/or pulverized solids, manually, presence or to program these settings at his/her personal preference. It is protected by a safety device. It consists of a BOX OF ELECTROMECHANICAL CONTROL SYSTEM consisting of a motor, transmissions, an electronic circuit, solenoids, switches and other electronic components. The BOX OF ELECTROMECHANICAL CONTROL SYSTEM opens and closes one or two valves, mixing the fluids, and it is operated through a control device, remote or fixed, programmable or non programmable, digital, presence or voice operated. The Digital Faucet of Variable Flow also can be operated through via Internet, telephone, cellular telephone or systems of programming. Any control, can be integrated upon the different types of outlet tube as part of these. The source of energy can be direct current, battery or solar cells.

2. THE BOX OF ELECTROMECHANICAL CONTROL SYSTEM as demanded in independent claim 1 and a dependent claim thereof, it is characterized by an electronic system composed of a motor, transmissions, solenoids and circuits and switches controlling the opening and closing of the valves as well as the timing of openness. This system controls the stream, flow progressiveness, mixture and timing of liquids, gases and/or pulverized solids, operated manually or by programmed settings when a memory device is available.

3. THE FIXED DIGITAL CONTROL as demanded in independent claim 1 and a dependent claim thereof. It is a modality of the control characterized by a specially structured circuit board, so the user operates the faucet from a fixed position. It offers various options to activate the faucet as to mixture, flow, flow progressiveness and timing. The commands are transmitted to the BOX OF ELECTROMECHANICAL CONTROL SYSTEM. The control may have or not a memory to program certain functions, depending on the modality of the control or it may be operated manually. This device contains an indicating scale to show the user the openness, closing of the valve and volume of the flow. The Fixed Digital Control may be operated through button pressing or digital presence.

4. THE DIGITAL REMOTE CONTROL as demanded in independent claim 1 and a dependent claim thereof. It is a modality of the CONTROL characterized by a specially designed circuit board to allow the user to operate the faucet from a remote position and select the various options to activate and operate the faucet. The commands are transmitted to the BOX OF ELECTROMECHANICAL CONTROL SYSTEM by radial frequency, infrared or a light beam. The remote control may be the kind that requires pressure of buttons or it operates through digital presence.

5. VOICE SYSTEM CONTROL as demanded in independent claim 1 and a dependent claim thereof. It is a modality of the CONTROL in addition to a digital control, characterized by a voice sensor specifically designed to allow the user to operate the faucet through a voice command instead of digital fixed or remote control.

6. THE INTELLIGENT CONTROL as demanded in independent claim 1 and a dependent claim thereof. It is a modality of the DIGITAL REMOTE CONTROL characterized by the device to maintain the user's settings in memory and to operate them through a command operated though button pressing or digital presence.

7. TRANSMISSIONS as demanded in independent claim 1 and a dependent claim thereof are devices for the BOX OF ELECTROMECHANICAL CONTROL SYSTEM in the DIGITAL FAUCET OF ONE OR TWO VALVES, characterized by its special design and structure to regulate speed and motor's motion force when opening and closing the valve or valves.

8. ELECTRONIC CIRCUIT as demanded in independent claim 1 and a dependent claim thereof, characteristically designed part of the BOX OF ELECTROMECHANICAL CONTROL SYSTEM that makes the changes of polarity to invert the voltage connected to the motor to turn the spin at the command's specification, through the application of relays, switches and other electronic components. Additionally, the electronic circuit made for the two valve faucet is connected to a set of two solenoids to pull alternatively, a transmission to connect it to one of the valve to open or close the valve chosen by the user's command. Connected to the timer, the electronic circuit also performs the function as the command to activate the motor to close the valve or valves as programmed It also has the function of showing the functioning of the faucet (flow progressiveness, stream, closure, etc.) through the indicating scale or display. This device has four variants as to structure depending on the type of the control used to operate, whether it is the remote or fixed, intelligent or non programmable, digital presence or voice operated, or without the solenoids in the case of the one valve faucet.

9. DIGITAL FAUCET OF VARIABLE FLOW OF A SINGLE VALVE. as demanded in independent claim 1 and a dependent claim thereof, characteristically that allow the user to control the opening and closing of the valve to control the stream, flow progressiveness and timing for liquids, gases or pulverized solids, manually or to program these settings at his/her personal preference. It is protected by a safety device. It consists of a BOX OF ELECTROMECHANICAL CONTROL SYSTEM that opens and closes one valve and it is operated through a control device, remote or fixed, programmable or non programmable, digital, presence or voice operated. The source of energy can be direct current, battery or solar cells.
